(19) United States
(12) Patent Application Publication
(10) Pub. No.: US 2025/0260262 A1
(43) Pub. Date: Aug. 14, 2025

(54) SIGNAL ROUNDS FOR ENERGY HARVESTING-CAPABLE DEVICES

(71) Applicant: QUALCOMM Incorporated, San Diego, CA (US)

(72) Inventors: Piyush GUPTA, Bridgewater, NJ (US); Zhifei FAN, San Diego, CA (US); Yuchul KIM, San Diego, CA (US); Chengjin ZHANG, San Diego, CA (US); Kazuki TAKEDA, Minato-ku (JP)

(21) Appl. No.: 19/052,158

(22) Filed: Feb. 12, 2025

Related U.S. Application Data
(60) Provisional application No. 63/553,327, filed on Feb. 14, 2024.

(51) Int. Cl. H02J 50/00; H04W 4/38

(52) U.S. Cl. CPC H02J 50/001; H04W 4/38

(57) ABSTRACT

Some wireless communications systems may support deployment of ambient internet of things (IoT) devices, which include relatively low power and low complexity devices that are capable of harvesting energy from different sources, including radio frequency (RF) waves, solar energy, heat, or other ambient sources. Energy harvesting (EH)-capable devices such as ambient IoT devices may be used for applications such as inventory tracking, sensing, positioning, or command systems. Ambient IoT devices may be deployed for inventory reading or tracking. In some of the approaches described herein, unsynchronized duty cycle-based operations at EH-capable devices (e.g., ambient IoT devices) and multiple queries in a round from a reader may be utilized. For example, some of the techniques described herein may provide approaches for efficiently multiplexing multiple queries from different inventory rounds. For example, an inventory round may include multiple signaling instances to query one or more ambient IoT devices.

### CROSS REFERENCE

The present Application for Patent claims the benefit of Provisional Patent Application No. 63/553,327 by GUPTA et al., entitled “SIGNAL ROUNDS FOR AMBIENT INTERNET OF THINGS DEVICES,” filed Feb. 14, 2024, which is assigned to the assignee hereof and is expressly incorporated by reference herein.

### TECHNICAL FIELD

The following relates to wireless communications, including signal rounds for energy harvesting-capable devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

In some of the approaches described herein, unsynchronized duty cycle-based operations at energy harvesting (EH)-capable devices (e.g., ambient Internet of Things (IoT) devices) and multiple queries in a round from a wireless device (e.g., reader) may be utilized. Some of the techniques described herein may provide approaches for efficiently multiplexing multiple queries from different inventory rounds. For example, an inventory round may include multiple signaling instances to query one or more EH-capable devices. In some approaches, rounds may be sequenced, where a second round occurs after a first round. In other approaches, queries from different rounds may be interspersed. Some approaches may include combining inventory rounds.

A method by a wireless device is described. The method may include outputting, within a first active period of an EH-capable device, first information associated with a first query for inventory data of the EH-capable device, the first information indicating a first inventory type and an instance of a first set of multiple instances associated with a first round of signaling from the wireless device, outputting second information associated with a second query for inventory data of the EH-capable device, the second information indicating a second inventory type and an instance of a second set of multiple instances associated with a second round of signaling from the wireless device, and obtaining an indication of inventory data for the first inventory type or the second inventory type from the EH-capable device in response to the first information or the second information.

A wireless device is described. The wireless device may include one or more memories storing processor executable code, and one or more processors coupled (e.g., operatively, communicatively, functionally, electronically, or electrically) with the one or more memories. The one or more processors (e.g., directly, indirectly, after pre-processing, without pre-processing) may individually or collectively be operable to execute the code to cause the wireless device to output, within a first active period of an EH-capable device, first information associated with a first query for inventory data of the EH-capable device, the first information indicating a first inventory type and an instance of a first set of multiple instances associated with a first round of signaling from the wireless device, output second information associated with a second query for inventory data of the EH-capable device, the second information indicating a second inventory type and an instance of a second set of multiple instances associated with a second round of signaling from the wireless device, and obtain an indication of inventory data for the first inventory type or the second inventory type from the EH-capable device in response to the first information or the second information.

Another wireless device is described. The wireless device may include means for outputting, within a first active period of an EH-capable device, first information associated with a first query for inventory data of the EH-capable device, the first information indicating a first inventory type and an instance of a first set of multiple instances associated with a first round of signaling from the wireless device, means for outputting second information associated with a second query for inventory data of the EH-capable device, the second information indicating a second inventory type and an instance of a second set of multiple instances associated with a second round of signaling from the wireless device, and means for obtaining an indication of inventory data for the first inventory type or the second inventory type from the EH-capable device in response to the first information or the second information.

A non-transitory computer-readable medium storing code for wireless communications at a wireless device is described. The code may include instructions executable by at least one processor (e.g., directly, indirectly, after pre-processing, without pre-processing) to output, within a first active period of an EH-capable device, first information associated with a first query for inventory data of the EH-capable device, the first information indicating a first inventory type and an instance of a first set of multiple instances associated with a first round of signaling from the wireless device, output second information associated with a second query for inventory data of the EH-capable device, the second information indicating a second inventory type and an instance of a second set of multiple instances associated with a second round of signaling from the wireless device, and obtain an indication of inventory data for the first inventory type or the second inventory type from the EH-capable device in response to the first information or the second information.

Some examples of the method, wireless devices, and non-transitory computer-readable medium described herein may further include operations, features, means, or instructions for outputting the second set of multiple instances associated with the second round of signaling subsequent to the first set of multiple instances associated with the first round of signaling.

In some examples of the method, wireless devices, and non-transitory computer-readable medium described herein, outputting the second information may include operations, features, means, or instructions for outputting the second information within a second active period subsequent to the first active period and a first inactive period of the EH-capable device.

In some examples of the method, wireless devices, and non-transitory computer-readable medium described herein, outputting the second information may include operations, features, means, or instructions for outputting, between two instances of the first set of multiple instances, the second information for the instance of the second set of multiple instances.

In some examples of the method, wireless devices, and non-transitory computer-readable medium described herein, outputting the second information may include operations, features, means, or instructions for outputting the second information within the first active period and prior to a first inactive period.

In some examples of the method, wireless devices, and non-transitory computer-readable medium described herein, outputting the second information may include operations, features, means, or instructions for outputting the second information for the instance of the second set of multiple instances with the first information for the instance of the first set of multiple instances, where at least one of the second set of multiple instances may be indicated with at least one of the first set of multiple instances.

In some examples of the method, wireless devices, and non-transitory computer-readable medium described herein, at least one of the second set of multiple instances may be separate from at least one of the first set of multiple instances.

In some examples of the method, wireless devices, and non-transitory computer-readable medium described herein, the first information and the second information implicitly indicate a quantity of rounds of signaling for the first inventory type and the second inventory type.

In some examples of the method, wireless devices, and non-transitory computer-readable medium described herein, the instance of the first set of multiple instances may be indicated as an offset relative to a previous instance of the first set of multiple instances or the instance of the second set of multiple instances may be indicated as an offset relative to the first set of multiple instances.

Some examples of the method, wireless devices, and non-transitory computer-readable medium described herein may further include operations, features, means, or instructions for obtaining an indication of a mapping between the inventory data and the first round of signaling or the second round of signaling.

A method by an EH-capable device is described. The method may include receiving, within a first active period, first information associated with a first query for inventory data of the EH-capable device from a wireless device, the first information indicating a first inventory type and an instance of a first set of multiple instances associated with a first round of signaling from the wireless device, receiving second information associated with a second query for inventory data of the EH-capable device from the wireless device, the second information indicating a second inventory type and an instance of a second set of multiple instances associated with a second round of signaling from the wireless device, and transmitting an indication of inventory data for the first inventory type or the second inventory type to the wireless device in response to the first information or the second information.

An EH-capable device is described. The EH-capable device may include one or more memories storing processor executable code, and one or more processors coupled (e.g., operatively, communicatively, functionally, electronically, or electrically) with the one or more memories. The one or more processors (e.g., directly, indirectly, after pre-processing, without pre-processing) may individually or collectively be operable to execute the code to cause the EH-capable device to receive, within a first active period, first information associated with a first query for inventory data of the EH-capable device from a wireless device, the first information indicating a first inventory type and an instance of a first set of multiple instances associated with a first round of signaling from the wireless device, receive second information associated with a second query for inventory data of the EH-capable device from the wireless device, the second information indicating a second inventory type and an instance of a second set of multiple instances associated with a second round of signaling from the wireless device, and transmit an indication of inventory data for the first inventory type or the second inventory type to the wireless device in response to the first information or the second information.

Another EH-capable device is described. The EH-capable device may include means for receiving, within a first active period, first information associated with a first query for inventory data of the EH-capable device from a wireless device, the first information indicating a first inventory type and an instance of a first set of multiple instances associated with a first round of signaling from the wireless device, means for receiving second information associated with a second query for inventory data of the EH-capable device from the wireless device, the second information indicating a second inventory type and an instance of a second set of multiple instances associated with a second round of signaling from the wireless device, and means for transmitting an indication of inventory data for the first inventory type or the second inventory type to the wireless device in response to the first information or the second information.

A non-transitory computer-readable medium storing code for wireless communications at an EH-capable device is described. The code may include instructions executable by at least one processor (e.g., directly, indirectly, after pre-processing, without pre-processing) to receive, within a first active period, first information associated with a first query for inventory data of the EH-capable device from a wireless device, the first information indicating a first inventory type and an instance of a first set of multiple instances associated with a first round of signaling from the wireless device, receive second information associated with a second query for inventory data of the EH-capable device from the wireless device, the second information indicating a second inventory type and an instance of a second set of multiple instances associated with a second round of signaling from the wireless device, and transmit an indication of inventory data for the first inventory type or the second inventory type to the wireless device in response to the first information or the second information.

In some examples of the method, EH-capable devices, and non-transitory computer-readable medium described herein, receiving the second information may include operations, features, means, or instructions for receiving the second information for the instance of the second set of multiple instances, where the second set of multiple instances associated with the second round of signaling occurs subsequent to the first set of multiple instances associated with the first round of signaling.

In some examples of the method, EH-capable devices, and non-transitory computer-readable medium described herein, receiving the second information may include operations, features, means, or instructions for receiving the second information within a second active period subsequent to the first active period and a first inactive period of the EH-capable device.

In some examples of the method, EH-capable devices, and non-transitory computer-readable medium described herein, receiving the second information may include operations, features, means, or instructions for receiving, between two instances of the first set of multiple instances, the second information for the instance of the second set of multiple instances.

In some examples of the method, EH-capable devices, and non-transitory computer-readable medium described herein, receiving the second information may include operations, features, means, or instructions for receiving the second information for the instance of the second set of multiple instances with the first information for the instance of the first set of multiple instances, where at least one of the second set of multiple instances may be indicated with at least one of the first set of multiple instances.

In some examples of the method, EH-capable devices, and non-transitory computer-readable medium described herein, at least one of the second set of multiple instances may be separate from at least one of the first set of multiple instances.

In some examples of the method, EH-capable devices, and non-transitory computer-readable medium described herein, the first information and the second information implicitly indicate a quantity of rounds of signaling for the first inventory type and the second inventory type.

In some examples of the method, EH-capable devices, and non-transitory computer-readable medium described herein, the instance of the first set of multiple instances may be indicated as an offset relative to a previous instance of the first set of multiple instances or the instance of the second set of multiple instances may be indicated as an offset relative to the first set of multiple instances.

Some examples of the method, EH-capable devices, and non-transitory computer-readable medium described herein may further include operations, features, means, or instructions for transmitting an indication of a mapping between the inventory data and the first round of signaling or the second round of signaling.

### BRIEF DESCRIPTION OF THE DRAWINGS

FIG. 1 shows an example of a wireless communications system that supports signal rounds for energy harvesting (EH)-capable devices in accordance with one or more aspects of the present disclosure.

FIG. 2 shows an example of a wireless communications system that supports signal rounds for EH-capable devices in accordance with one or more aspects of the present disclosure.

FIG. 3 shows an example of a wireless communications system that supports signal rounds for EH-capable devices in accordance with one or more aspects of the present disclosure.

FIG. 4 shows examples of timing diagrams that support signal rounds for EH-capable devices in accordance with one or more aspects of the present disclosure.

FIG. 5 shows an example of a process flow that supports signal rounds for EH-capable devices in accordance with one or more aspects of the present disclosure.

FIGS. 6 and 7 show block diagrams of devices that support signal rounds for EH-capable devices in accordance with one or more aspects of the present disclosure.

FIG. 8 shows a block diagram of a communications manager that supports signal rounds for EH-capable devices in accordance with one or more aspects of the present disclosure.

FIG. 9 shows a diagram of a system including a device that supports signal rounds for EH-capable devices in accordance with one or more aspects of the present disclosure.

FIGS. 10 and 11 show block diagrams of devices that support signal rounds for EH-capable devices in accordance with one or more aspects of the present disclosure.

FIG. 12 shows a block diagram of a communications manager that supports signal rounds for EH-capable devices in accordance with one or more aspects of the present disclosure.

FIG. 13 shows a diagram of a system including a device that supports signal rounds for EH-capable devices in accordance with one or more aspects of the present disclosure.

FIGS. 14 through 17 show flowcharts illustrating methods that support signal rounds for EH-capable devices in accordance with one or more aspects of the present disclosure.

### DETAILED DESCRIPTION

Some wireless communications systems may support deployment of ambient Internet of Things (IoT) devices, which may include relatively low power or low complexity devices that are capable of harvesting energy from different sources, including radio frequency (RF) waves, solar energy, heat, or other ambient sources. Energy harvesting (EH)-capable devices such as ambient IoT devices may be used for applications such as inventory tracking, sensing, positioning, or command systems. For example, for command systems, EH-capable devices may be used for such applications as control of irrigations systems, dispensing medicine, or providing alerts.

Ambient IoT devices may be deployed for inventory reading or tracking. In some approaches, inventory tracking may be modeled as reading a quantity of tags per second. In an automobile factory, for example, a reader may read approximately 100 tags/s, with 1300 readers deployed to cover 600,000 square miles and approximately 800,000 tags in total. Inventory reading may be performed periodically or on-demand. For instance, in a retail set-up, inventory goods may be read every 15 minutes, or when initiated on-demand. In addition, a latency threshold may be demanded in completing an inventory round. For instance, an inventory reading may be completed within a quantity of seconds (e.g., one second in automated warehousing).

An ambient IoT device may be able to receive a reader's inventory query and respond within a specified latency constraint (e.g., X s). To conserve energy, an ambient IoT device may be in sleep mode often. Unlike some approaches for radio frequency identification (RFID), an energy harvesting rate at longer range may be demanded for ambient IoT devices (e.g., 30+ meters, which may be insufficient to sustain query decoding). In some cases, an ambient IoT device may rely on stored energy. Asynchronous operation or continuous monitoring for receiving queries at the ambient IoT device may drain stored energy. One current challenge is to specify operations for an ambient IoT tag and a reader and signaling to satisfy the inventory latency constraints and maintain energy efficiency for prolonged operation.

In some of the approaches described herein, unsynchronized duty cycle-based operations at ambient IoT devices or multiple queries in a round from a reader may be utilized. For example, some of the techniques described herein may provide approaches for efficiently multiplexing multiple queries from different inventory rounds. For example, an inventory round may include multiple signaling instances to query one or more ambient IoT devices. In some approaches, rounds may be sequenced, where a second round occurs after a first round. In other approaches, queries from different rounds may be interspersed. Some approaches may include combining inventory rounds. Some examples of the techniques described herein may be implemented or applied in contexts (e.g., a warehouse context, among other examples) where a significant quantity of devices may be utilized, or where latency and contention issues may occur.

Aspects of the disclosure are initially described in the context of wireless communications systems. Aspects of the disclosure are further illustrated by and described with reference to timing diagrams and a process flow that relate to signal rounds for EH-capable devices. Aspects of the disclosure are further illustrated by and described with reference to apparatus diagrams, system diagrams, and flowcharts that relate to signal rounds for EH-capable devices.

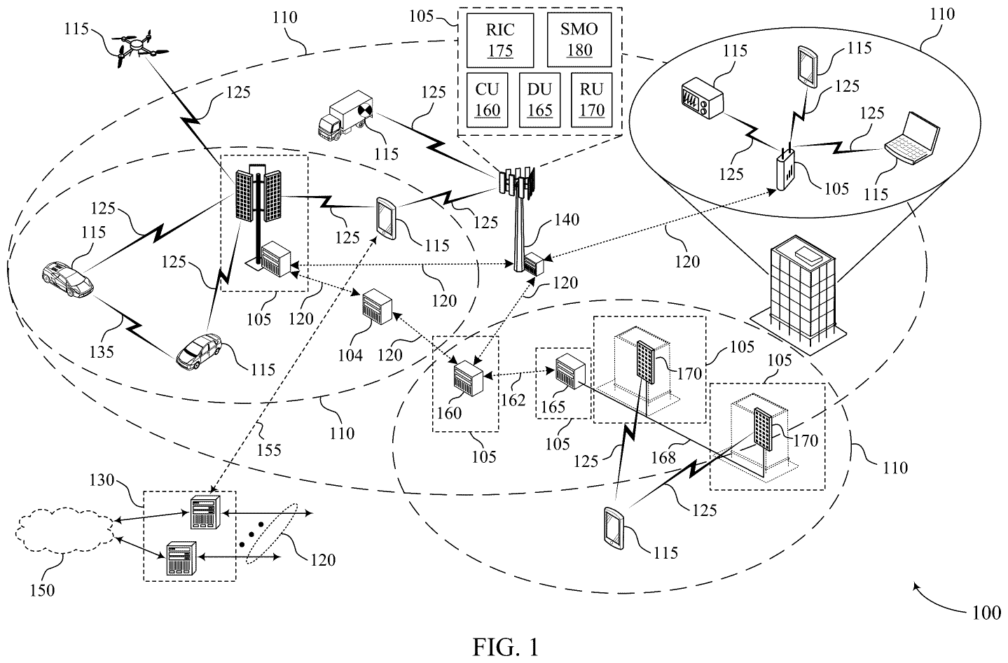

FIG. 1 shows an example of a wireless communications system 100 that supports signal rounds for EH-capable devices in accordance with one or more aspects of the present disclosure. The wireless communications system 100 may include one or more devices, such as one or more network devices (e.g., network entities 105), one or more user equipments (UEs) 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHZ)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems may support deployment of ambient IoT devices, which may include relatively low power or low complexity devices that are capable of harvesting energy from different sources, including RF waves, solar energy, heat, or other ambient sources. EH-capable devices such as ambient IoT devices may be used for applications such as inventory tracking, sensing, positioning, or command systems. For example, for command systems, EH-capable devices may be used for such applications as control of irrigations systems, dispensing medicine, or providing alerts. In some aspects, one or more UEs 115 may be EH-capable devices.

Ambient IoT devices may be deployed for inventory reading or tracking. In some approaches, inventory tracking may be modeled as reading a quantity of tags per second. In an automobile factory, for example, a reader (e.g., a network entity 105 or a UE 115) may read approximately 100 tags/s, with 1300 readers deployed to cover 600,000 square miles and approximately 800,000 tags in total. Inventory reading may be performed periodically or on-demand. For instance, in a retail set-up, inventory goods may be read every 15 minutes, or when initiated on-demand. In addition, a latency threshold may be demanded in completing an inventory round. For instance, an inventory reading may be completed within a quantity of seconds (e.g., one second in automated warehousing).

An ambient IoT device may be able to receive a reader's inventory query and respond within a specified latency constraint (e.g., X s). To conserve energy, an ambient IoT device may be in sleep mode often. Unlike some approaches for RFID, an energy harvesting rate at longer range may be demanded for ambient IoT devices (e.g., 30+ meters, which may be insufficient to sustain query decoding). In some cases, an ambient IoT device may rely on stored energy. Asynchronous operation or continuous monitoring for receiving queries at the ambient IoT device may drain stored energy. One current challenge is to specify operations for an ambient IoT tag and a reader and signaling to satisfy the inventory latency constraints and maintain energy efficiency for prolonged operation.

In some of the approaches described herein, unsynchronized duty cycle-based operations at ambient IoT devices or multiple queries in a round from a reader (e.g., network entity 105 or UE 115) may be utilized. For example, some of the techniques described herein may provide approaches for efficiently multiplexing multiple queries from different inventory rounds. For example, an inventory round may include multiple signaling instances to query one or more ambient IoT devices. In some approaches, rounds may be sequenced, where a second round occurs after a first round. In other approaches, queries from different rounds may be interspersed. Some approaches may include combining inventory rounds. Some examples of the techniques described herein may be implemented or applied in contexts (e.g., a warehouse context, among other examples) where a significant quantity of devices may be utilized, or where latency and contention issues may occur.

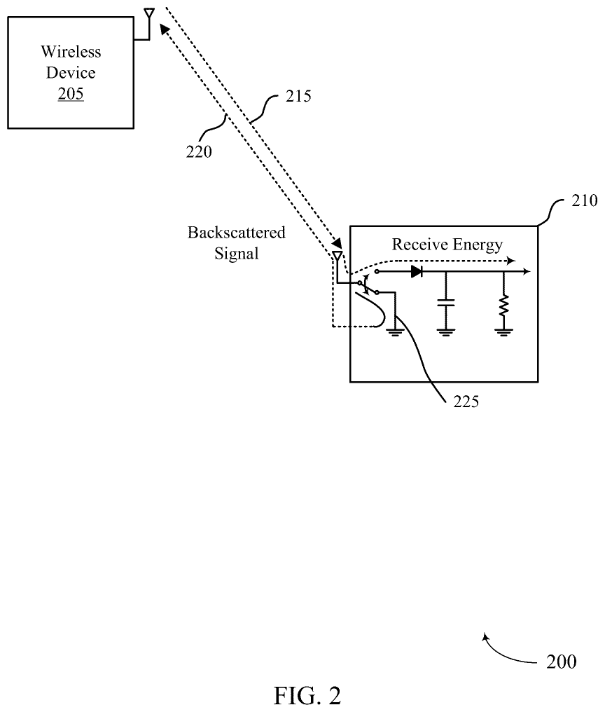

FIG. 2 shows an example of a wireless communications system 200 that supports signal rounds for EH-capable devices in accordance with one or more aspects of the present disclosure. The wireless communications system 200 may implement aspects of the wireless communications system 100.

The wireless communications system 200 may include a wireless device 205. In some approaches, the wireless device 205 may be an example of a UE 115 or a network entity 105 as described herein. The wireless device 205 may be referred to as a wireless communication device. In some aspects, the wireless device 205 may be an example of an energy transfer device or an RFID reader. The wireless communications system 200 may include an EH-capable device 210. In some examples, the EH-capable device 210 may be a UE 115 as described herein. The EH-capable device 210 may be capable of performing backscattering based communication. In some examples, the EH-capable device 210 may be an example of an IoT device, an ambient IoT device, an RFID tag, or any combination thereof. EH-capable devices may harvest energy over the air (e.g., via reception of an interrogating signal 215). In response to the interrogating signal 215 (e.g., using the energy of the interrogating signal 215), power transmission/reception circuitry 225 may transmit a responsive signal 220. Responsive signals 220 transmitted by RFID devices may be backscatter modulated (e.g., referred to as backscatter responses). In some examples, RFID devices may be semi-passive or active and may include an energy storage device (e.g., a battery). In some examples, a wireless communications system may support a bistatic structure, where one network device (e.g., the wireless device 205) transmits an energy transfer signal (e.g., the interrogating signal 215) to the EH-capable device 210 and another network device may receive the responsive signal 220 (e.g., may communicate with the EH-capable device).

EH-capable devices may be passive, semi-passive, or active. Table 1 below shows characteristics of passive, semi-passive, and active EH-capable devices. Example applications for passive EH-capable devices include access or proximity cards. Example applications for semi-passive EH-capable devices include electronic tolls or pallet tracking. Example applications for active EH-capable devices include large asset tracking or livestock tracking.

TABLE 1

| EH-Capable | | | |
|---|---|---|---|
| Device Type | Passive | Semi-Passive | Active |
| Power Source | Harvesting energy | Harvesting energy | Harvesting energy |
| | (e.g., RF energy, | (e.g., RF energy, | (e.g., RF energy, |
| | solar, heat) | solar, heat), battery | solar, heat), battery |
| Communication | Response only | Response only | Respond or initiate |
| type | | | |
| Approximate | 10M | >100M | >100M |
| Maximum Range | | | |
| Relative Cost | Least expensive | More expensive | Most expensive |

Passive EH-capable devices may have short range capability (e.g., less than 10 meters) due to insufficient link budget issues and poor communication reliability. For example, the maximum transmit power by the wireless device 205 may be limited for the transmission band. For example, the effective isotropic radiated power (EIRP) for the network device may be 36 decibel-milliwatts (dBm). As another example, weak reflected backscatter signal by passive EH-capable devices may limit the range of the passive EH-capable devices. As passive EH-capable devices are power limited, the reflected signal power strength is approximately inversely proportional to the fourth power of the distance

$$\frac{1}{{d}^{4}} .$$

Another issue affecting the range of passive EH-capable devices may be interference from other reader devices, other tags, or other communications systems. CRC may be used for error detection for signals involving passive EH-capable devices.

As described herein, ambient IoT devices such as the EH-capable device 210 may be used for inventory use cases in indoor or outdoor environments. For example, Table 2 shows different example use cases for indoor ambient IoT devices and parameters associated with the use cases. Table 3 shows different example use cases for outdoor ambient IoT devices and parameters associated with the use cases. Table 2 or Table 3 illustrate examples of use cases, message size (in bits), report data, a reporting period (for Table 2), latency (in seconds), positioning accuracy (in meters at 90%), device density (/100 meters squared), and moving speed (in kilometers (km) per hour (hr)). For convenience, the term “management” is abbreviated as “mgmt.” in Table 2 and Table 3.

TABLE 2

| | | | | | Position | Device | |
|---|---|---|---|---|---|---|---|
| | | | Report | | Accuracy | Density | |
| | Size | Report | period | Latency | (m at | (/100 | Speed |
| Use Case | (bits) | Data | (min) | (s) | 90%) | m²) | (km/hr) |
| Automated | 96/128 | Device | — | 1 | 2-3 | — | 5-10 |
| warehousing | | ID or | | | | | |
| Medical | 176 | position | — | Several | 3-5 | ≥0.1 | <6 |
| instruments | | | | seconds | | | |
| inventory | | | | | | | |
| mgmt. and | | | | | | | |
| positioning | | | | | | | |
| Non-Public | — | | — | — | — | — | — |
| Network for | | | | | | | |
| logistics | | | | | | | |
| Automobile | 96 | | — | >0.1 | 3 | <150 | — |
| manufacturing | | | | (>100 | | | |
| | | | | tags/s) | | | |
| Airport | 256 | | — | 1-10 | Cell | 0.01 | 3-10 |
| terminal/ | | | | | level | | |
| shipping port | | | | | | | |
| Smart laundry | <800 | | — | >10 | — | 20 | <6 |
| Automated | <800 | | — | >10 | Indoor: 3 | <150 | — |
| supply chain | | | | | Outdoor: | | |
| distribution | | | | | cell level | | |
| Fresh food | <100 | | 15 | >60 | — | 150 | 3.6 |
| supply chain | | | | | | | |
| End-to-end | — | | — | — | — | — | — |
| logistics | | | | | | | |
| Flower | 96 | | — | 10 | — | <130 | — |
| auction | | | | | | | |
| Electronic | 96 | | | | | | |
| shelf label | | | | | | | |

TABLE 3

| | | | | Position | Device | |
|---|---|---|---|---|---|---|
| | Message | | | Accuracy | Density | Moving |
| | Size | Report | Latency | (m at | (/100 | speed |
| Use Case | (bits) | Data | (s) | 90%) | m²) | (km/hr) |
| Medical | 176 | Device ID/ | Several | 3-5 | ≥0.1 | <6 |
| instruments | | position | seconds | | | |
| inventory | | | | | | |
| mgmt. and | | | | | | |
| positioning | | | | | | |
| Non-Public | — | | — | — | — | — |
| Network for | | | | | | |
| logistics | | | | | | |
| Airport | 256 | | 1-10 | Cell level | 0.01 | 3-10 |
| terminal/ | | | | | | |
| shipping | | | | | | |
| port | | | | | | |
| Automated | <800 | | >10 | Indoor: 3 | — | — |
| supply | | | | Outdoor: | | |
| chain | | | | cell level | | |
| distribution | | | | | | |

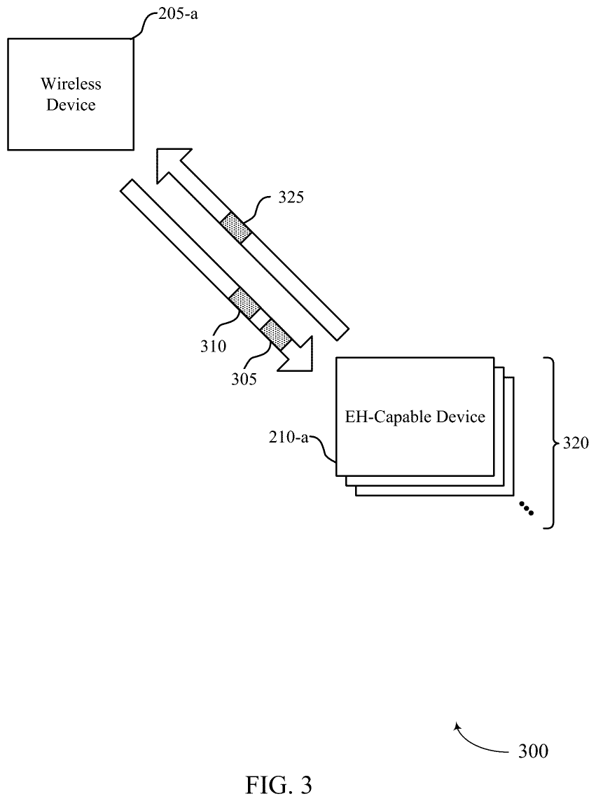

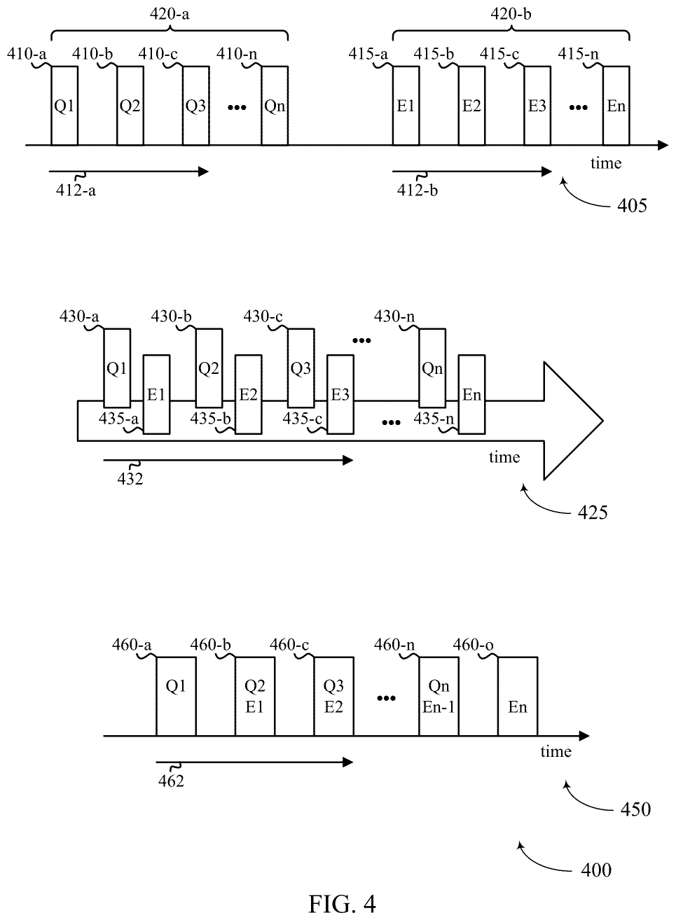

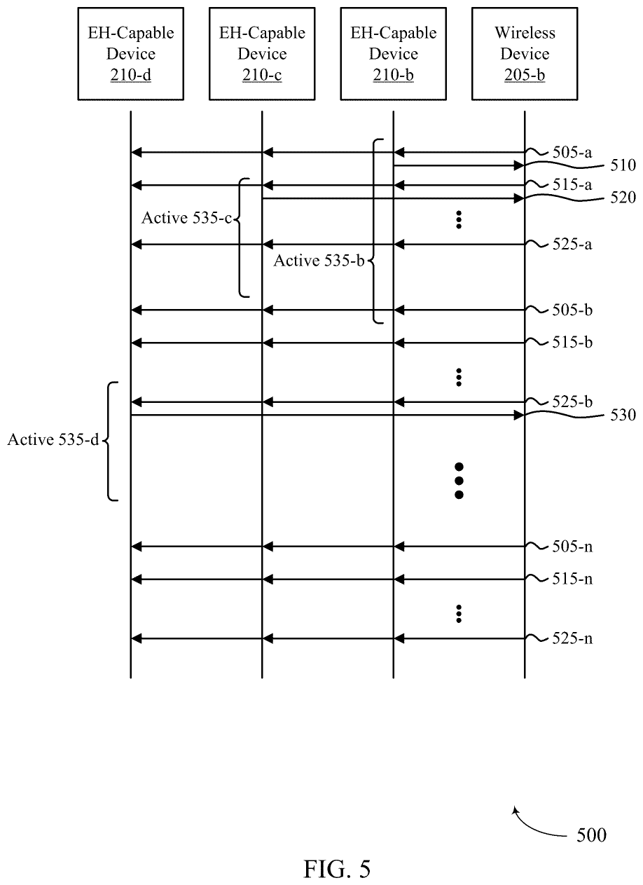

In some examples, the wireless device 205 may be implemented with one or more of the structures, or may be implemented to perform one or more of the operations described with reference to FIG. 3, FIG. 4, or FIG. 5. Additionally, or alternatively, the EH-capable device 210 may be implemented with one or more of the structures, or may be implemented to perform one or more of the operations described with reference to FIG. 3, FIG. 4, or FIG. 5.

FIG. 3 shows an example of a wireless communications system 300 that supports signal rounds for EH-capable devices in accordance with one or more aspects of the present disclosure. The wireless communications system 300 may implement aspects of the wireless communications system 100 or the wireless communications system 200. For example, the wireless communications system 300 includes a wireless device 205-a, which may be an example of a wireless device 205 as described herein. In some cases, the wireless device 205-a may be referred to as a reader or reader device. As another example, the wireless communications system 300 includes at least one EH-capable device 210-a, which may be an example of an EH-capable device 210 as described herein. An electronic tag may be one example of the EH-capable device 210-a.

Some examples of the techniques described herein may provide one or more inventory or command operations for one or more EH-capable devices 320 (e.g., ambient IoT device(s)). In some aspects, one or more of the EH-capable devices 320 may operate in accordance with an active period and an inactive period. For instance, an EH-capable device 210-a may operate in accordance with a duty cycle, where the EH-capable device 210-a is active (e.g., activated for one or more communications or one or more other operations) for a portion of the duty cycle or is inactive (e.g., deactivated from communicating or performing one or more other operations). For example, an EH-capable device may wake up periodically to communicate or perform one or more operations. In some approaches, the EH-capable device 210-a may activate periodically (e.g., may wake up every X seconds) and may remain active during the active period (e.g., for Y seconds of the X seconds). In some examples, X=1 s and Y=25 ms. Other values may be utilized in some examples. The periodic operation of the EH-capable device 210-a may help to reduce latency (e.g., satisfy latency targets) or enhance energy efficiency.

In some cases, an active period or an inactive period may differ between two or more of the EH-capable devices 320. For example, the duty cycle may not be synchronized across the EH-capable devices 320. To address the lack of synchronized active periods of the EH-capable device 320 (e.g., due to relatively large clock drifts), the wireless device 205-a (e.g., reader) may output (e.g., transmit or send) multiple queries. A query may be a signal that requests, instructs, or commands a response. For instance, a query may be a signal that requests inventory data or commands an operation for an EH-capable device 210-a. As used herein, a “round” may denote a set of queries or a period for communicating a set of queries.

In some examples, queries may be communicated (e.g., transmitted or received) periodically. For instance, queries may be communicated with a period of Z seconds (e.g., Z=10 ms) within a round. In some aspects, a query may be communicated within a portion (e.g., a subset) of the period of Z seconds. In some approaches, X≥Y≥Z or another relationship may exist between X, Y, or Z. A quantity of n (e.g., n=100) queries may be communicated within a round. In some aspects, the wireless device 205-a (e.g., reader) may transmit the n queries (e.g., Qi, where 1≤i≤n) in a round (e.g., in an inventory or command round). Some of the techniques described herein may provide signaling, procedures, or multiplexing for one or more queries.

In some examples, multiple rounds (e.g., inventory rounds) may be multiplexed. For instance, the wireless device 205-a may output queries for multiple inventory rounds (e.g., one round for milk cartons, one round for egg cartons, or one round for dairy goods, among other examples). Multiplexing the multiple rounds may be performed in one or more approaches. In some approaches, multiple rounds may be signaled sequentially (e.g., a first inventory round followed by a second inventory round and so on), with interleaving (e.g., queries from rounds may be interspersed), or with combining (e.g., queries from different inventory types may be combined).

As used herein, ordinal terms (e.g., “first,” “second,” or “third,” among other examples) may not necessarily indicate an order or sequence in time. In some cases, ordinal terms (e.g., “first,” “second,” or “third,” among other examples) may indicate an order or sequence in time. While some examples are given herein in terms of “first” and “second” elements, some of the techniques described herein may be applied to more or fewer elements.

The wireless device 205-a may output (e.g., transmit), within a first active period of the EH-capable device 210-a, first information 305 associated with a first query for inventory data of the EH-capable device 210-a. One or more of the EH-capable devices 320 (e.g., the EH-capable device 210-a) may receive the first information 305. The first information 305 may indicate a first inventory type and an instance of a first set of instances associated with a first round of signaling from the wireless device 205-a. For example, the first information 305 may include a value(s), code(s), bit(s), or indicator(s) of the first inventory type. The first inventory type may be associated with (e.g., may indicate) a product, item, or category of items (e.g., milk, eggs, broccoli, hygiene products, medicines, towels, shoes, vehicle make and model, electronic components, manufacturing components, gift cards, luggage, clothing, appliances, or tools, among other examples).

The instance of the first round may be associated with a query of the first round. For example, the first information 305 may include a value(s), code(s), bit(s), or indicator(s) of the instance. In some aspects, the instance of the first round may be an indicator of a count, order, sequence, or identifier of a query in a set of queries of the first round. For example, the instance may be a quantity (e.g., 1, 2, 3, 4, . . . , n) corresponding to a query of the first round. In some aspects, the instance may indicate, to the EH-capable device 210-a, which query is being signaled in a set of queries of the first round. For example, if the EH-capable device 210-a enters an active state and receives the first information 305 with an instance of 19 with a product type indicating milk, the instance may indicate to the EH-capable device 210-a that previous queries with instances of 1-18 were not received or that subsequent queries with instances of 20-100 will be signaled. In some approaches, the instance may enable the EH-capable device 210-a to disregard later instances of queries of the first round if the EH-capable device 210-a has already responded to a query of the first round or to determine the timing for an end (or beginning) of a round (e.g., of the first round or of another round).

The wireless device 205-a may output (e.g., transmit) second information 310 associated with a second query for inventory data of the EH-capable device 320. One or more of the EH-capable devices 320 (e.g., the EH-capable device 210-a) may receive the second information 310. The second information 310 may indicate a second inventory type and an instance of a second set of instances associated with a second round of signaling from the wireless device 205-a. For example, the first information 305 may include a value(s), code(s), bit(s), or indicator(s) of the second inventory type. The second inventory type may be different from the first inventory type. For example, the second inventory type may be associated with (e.g., may indicate) a product, item, or category of items that is different from the first inventory type.

The instance of the second round may be associated with a query of the second round. For example, the second information 310 may include a value(s), code(s), bit(s), or indicator(s) of the instance. In some aspects, the instance of the second round may be an indicator of a count, order, sequence, or identifier of a query in a set of queries of the second round. For example, the instance may be a quantity (e.g., 1, 2, 3, 4, . . . , n) corresponding to a query of the second round. In some aspects, the instance may indicate, to the EH-capable device 210-a, which query is being signaled in a set of queries of the second round. In some approaches, the instance of the second round may enable the EH-capable device 210-a to disregard later instances of queries of the second round if the EH-capable device 210-a has already responded to a query of the second round or to determine the timing for an end (or beginning) of a round (e.g., of the second round or of another round).

The EH-capable device 210-a may transmit an indication 325 of inventory data for the first inventory type or the second inventory type to the wireless device 205-a in response to the first information 305 or the second information 310. The wireless device 205-a may obtain the indication 325 from the EH-capable device 210-a in response to the first information 305 or the second information 310. For example, the EH-capable device 210-a may respond to the first information 305 or to the second information 310 in a case that the EH-capable device 210-a has inventory data corresponding to the inventory type indicated by the first information 305 or the second information 310 (e.g., first inventory data corresponding to a first inventory type indicated by the first information 305, or second inventory data corresponding to a second inventory type indicated by the second information 310).

In an example, if the EH-capable device 210-a is a tag with a type (e.g., penicillin) included in (or matching) the inventory type (e.g., antibiotics) indicated by the first information 305, but has a type (e.g., penicillin) that does not correspond to the inventory type (e.g., dairy products) indicated by the second information 310, the EH-capable device 210-a may transmit the indication 325 of the inventory data in response to the first information 305, and may not respond to the second information 310. In some approaches, the EH-capable device 210-a may disregard or ignore one or more further instances of queries of the second round. Additionally, or alternatively, the EH-capable device 210-a may disregard or ignore one or more further instances of queries of the first round after a threshold quantity of responses (e.g., 1, 2, 3, 5, 10, or 20, among other examples).

In some aspects, the wireless device 205-a may multiplex the first information 305 and the second information 310. Multiplexing the first information 305 and the second information 310 may enable reduced latency or greater communication throughput for multiple rounds (e.g., inventory types) while allowing power savings via the duty cycle of one or more of the EH-capable devices 320.

In some aspects, the first information 305 and the second information 310 may be multiplexed sequentially. The wireless device 205-a may output (e.g., transmit) the second set of instances associated with the second round of signaling subsequent to the first set of instances associated with the first round of signaling. The EH-capable device 210-a may receive the second set of instances (e.g., the second round) subsequent to the first set of instances (e.g., the first round). For example, the wireless device 205-a may transmit a first set of instances of a first round for milk cartons, followed by a second set of instances of a second round for eggs. While two rounds are provided in accordance with some of the examples herein, two or more rounds of signaling (e.g., two or more sets of instances) may be communicated.

In some approaches, the wireless device 205-a may output (e.g., transmit) the second information 310 within a second active period subsequent to the first active period and a first inactive period of the EH-capable device 210-a. For example, the first information 305 may be transmitted and received during the first active period of the EH-capable device 210-a. The EH-capable device 210-a may then enter a first inactive period (e.g., a sleep period). After the first active period and the first inactive period, the wireless device 205-a may transmit the second information 310, and the EH-capable device 210-a may receive the second information 310, within the second active period. In some cases, the second active period may occur at any time subsequent to the first active period and the first inactive period (e.g., 1, 2, 5, 10, or any quantity of cycles after the first inactive period). For example, the second active period (and the communication of the second information 310 for the second round) may occur after a 10th instance of the first round. In some examples, a delay in starting the second round may be any quantity of time depending on an initiation of the second round from a higher layer (e.g., the application layer).

In some cases, sequential multiplexing may allow lower complexity signaling or processing at the EH-capable devices 320 (e.g., tags) because the EH-capable devices may not concurrently track multiple rounds. Sequential multiplexing may not be feasible for some use cases due to latency constraints. An example of sequential multiplexing of instances of queries corresponding to different rounds is given with reference to FIG. 4.

In some approaches, the wireless device 205-a may employ interleaving or interspersion (e.g., TDM) for instances of queries of different rounds. For example, queries between (e.g., from different) rounds may be interspersed. The wireless device 205-a may output (e.g., transmit), between two instances of the first set of instances, the second information 310 for the instance of the second set of instances. The EH-capable device 210-a may receive the second information 310 for the instance of the second set of instances (e.g., a query of the second round) between two instances of the first set of instances. In multiplexing using interleaving or interspersion, the EH-capable device 210-a may track multiple rounds concurrently. An example of interleaving or interspersing instances of queries corresponding to different rounds is given with reference to FIG. 4.

In some cases, the wireless device 205-a may initiate rounds when an application-level request is received (e.g., received at a lower level than the application level, such as at the MAC level or PHY level). Interspersing queries from different rounds may allow the initiation of a new round of queries within an ongoing round.

In some examples, the wireless device 205-a may output the second information 310 within the first active period and prior to a first inactive period. For instance, the first information 305 and the second information 310 (or information for one or more additional rounds) may be signaled in the same active period, which may help satisfy latency constraints for multiple (e.g., all) rounds. The same active period of the EH-capable device 210-a (e.g., tag) may allow instances of queries corresponding to multiple (e.g., two or more) rounds.

The wireless device 205-a may multiplex the first information 305 and the second information 310 by combining rounds in some approaches. The wireless device 205-a may output (e.g., transmit) the second information 310 for the instance of the second set of instances with the first information 305 for the instance of the first set of instances. One or more of the second set of instances may be one or more of the first set of instances. The EH-capable device 210-a may receive the second information 310 with the first information 305. In multiplexing by combining rounds, the EH-capable device 210-a may track multiple rounds concurrently.

With combined inventory rounds, a query may include information for multiple inventory types (e.g., both milk and egg cartons). In some cases, both rounds may start together. For example, an initial query for milk can be communicated in the same instance at an initial query for egg cartons. An example of interleaving or interspersing instances of queries corresponding to different rounds is given with reference to FIG. 4.

In some examples, combined inventory rounds may be performed asynchronously. For example, one or more of the second set of instances may overlap with one or more of the first set of instances, and one or more of the second set of instances may be separate from one or more of the first set of instances. For example, if each round lasts X seconds and the queries contain compatible information, the information from different rounds may be combined. In some approaches, one or more of the EH-capable devices 320 (e.g., tags) may determine whether to respond further after one or more responses to preceding queries in a current active period (e.g., wake-up duration). For instance, if the EH-capable device 210-a has already responded to a threshold quantity of queries in the current active period, the EH-capable device 210-a may not respond to further queries for the same inventory type in the current active period.

An example of a format for combined inventory rounds is given in Table 4.

TABLE 4
Quantity of Rounds = L

| | |
|---|---|
| Round 1 | Query # of 1 |
| Round 2 | Query # of 2 |
| . | . |
| . | . |
| . | . |
| Round L | Query # of L |

Each instance of a combined query may indicate a round identifier and query quantity (e.g., index or number) corresponding to the round in some approaches.

In some aspects, one or more compression techniques may be utilized. For example, the round identifier may be omitted or may be indicated implicitly. The first information 305 and the second information 310 may implicitly indicate a quantity of rounds of signaling for the first inventory type and the second inventory type. For example, a quantity of query fields (e.g., query indices or numbers) in a query may implicitly indicate a quantity of rounds.

In some aspects, a query quantity (e.g., query index or number) may be relative to an offset (rather than being absolute). For example, the instance of the first set of instances may be indicated as an offset relative to a previous instance of the first set of instances. Additionally, or alternatively, the instance of the second plurality of instances may be indicated as an offset relative to the first plurality of instances. For example, an offset may be relative among rounds. If an instance of one round differs from an instance of another round by a quantity, the instance of the other round may be indicated as an offset of the quantity relative to the one round. Utilizing an offset may utilize smaller quantities (or avoid repeating relatively large quantities) by indicating instances of one round with absolute quantities and instances of one or more other rounds with offsets relative to the one round. Relatively smaller quantities may be represented with fewer bits.

In some cases, combining inventory rounds may incur a relatively small additional delay (e.g., <Z seconds, or 10 ms). Combining inventory rounds may reduce query overhead and energy consumption of the EH-capable device 210-a (e.g., tag). For example, a quantity of queries may be reduced (e.g., from 2n to (n+1) for overlapping instances except 1) due to queries being combined in overlapping instances.

In some approaches, the EH-capable device 210-a may transmit an indication of a mapping between the inventory data and the signaling round (e.g., the first round of signaling or the second round of signaling). The wireless device 205-a may obtain (e.g., receive) the indication of the mapping. For example, the EH-capable device 210-a (e.g., tag) may transmit include an explicit mapping to one or more inventory rounds with the inventory data. In some use cases where an identifier of the EH-capable device 210-a is signaled for the inventory data, combining the inventory rounds may reduce transmitted data by avoiding repetition of the identifier for multiple inventory types.

FIG. 4 shows examples of timing diagrams 400 that support signal rounds for EH-capable devices in accordance with one or more aspects of the present disclosure. The timing diagrams 400 may implement aspects of the wireless communications system 100, the wireless communications system 200, or the wireless communications system 300. In FIG. 4, Q1-Qn may correspond to a round of signaling (e.g., queries of a round), or E1-En may correspond to another round of signaling (e.g., queries of another round).

The first timing diagram 405 illustrates an example of sequential query multiplexing. The first timing diagram 405 illustrates a first round 420-a of signaling and a second round 420-b of signaling. The first round 420-a of signaling may include queries 410-a to 410-n corresponding to a first inventory type. The second round 420-b of signaling may include queries 415-a to 415-n corresponding to a second inventory type. In this example, three queries 410-a, 410-b, and 410-c of the first round 420-a for the first inventory type occur during a first active period 412-a of an EH-capable device (e.g., EH-capable device 210-a). Three queries 415-a, 415-b, and 415-c of the second round 420-b for the second inventory type occur during a second active period 412-b of an EH-capable device (e.g., EH-capable device 210-a). Sequential multiplexing may allow relative lower signaling or processing complexity at an EH-capable device, as the EH-capable device may not tracking multiple rounds concurrently.

The second timing diagram 425 illustrates an example of multiplexing using interleaving or interspersion. The second timing diagram 425 illustrates a first round of signaling and a second round of signaling. The first round of signaling may include queries 430-a to 430-n corresponding to a first inventory type. The second round of signaling may include queries 435-a to 435-n corresponding to a second inventory type. In this example, three queries 430-a, 430-b, and 430-c of the first round for the first inventory type and three queries 435-a, 435-b, and 435-c of the second round for the second inventory type occur during an active period 432 of an EH-capable device (e.g., EH-capable device 210-a). Multiplexing using interleaving or interspersion may reduce latency between rounds, which may enable meeting latency constraints for multiple inventory types or rounds.

The third timing diagram 450 illustrates an example of multiplexing by combining rounds. The third timing diagram 450 illustrates a first round of signaling and a second round of signaling. The first round of signaling may include queries 460-a to 460-n corresponding to a first inventory type. The second round of signaling may include queries 460-b to 460-o corresponding to a second inventory type. In this example, three queries 460-a, 460-b, and 460-c of the first round for the first inventory type and two queries 460-b and 460-c of the second round for the second inventory type occur during an active period 462 of an EH-capable device (e.g., EH-capable device 210-a). Multiplexing using interleaving or interspersion may reduce latency between rounds, may reduce signaling for multiple inventory types, or may allow for one or more types of compression or implicitly signaling.

FIG. 5 shows an example of a process flow 500 that supports signal rounds for EH-capable devices in accordance with one or more aspects of the present disclosure. The process flow 500 may include a wireless device 205-b, which may be an example of a wireless device 205 (e.g., wireless device 205-a) as described herein. The process flow 500 includes a first EH-capable device 210-b, a second EH-capable device 210-c, and a third EH-capable device 210-d, which may examples of an EH-capable device 210 (e.g., EH-capable device 210-a) as described herein. In the following description of the process flow 500, the operations between the wireless device 205-b and the EH-capable devices 210-b, 210-c, 210-d may be transmitted in a different order than the example order shown, or the operations performed by the wireless device 205-b and the EH-capable devices 210-b, 210-c, 210-d may be performed in different orders or at different times. Some operations may also be omitted from the process flow 500, or other operations may be added to the process flow 500.

At 505-a, the wireless device 205-b may output, to the EH-capable devices 210-b, 210-c, 210-d, a first instance of a first query of a first round of signaling. The first round of signaling may include queries at (e.g., instances) 505-a and 505-b to 505-n. In the example of FIG. 5, the first EH-capable device 210-b may be within a first active period 535-b when the first query is communicated (e.g., transmitted or received).

At 510, the first EH-capable device 210-b may transmit first inventory data. For example, the first query may have an inventory type corresponding to the first EH-capable device 210-b and may be received within the first active period 535-b of the first EH-capable device 210-b. Accordingly, the first EH-capable device 210-b may respond by transmitting the first inventory data. Because the second EH-capable device 210-c and the third EH-capable device 210-d are not active when the first query is transmitted, the second EH-capable device 210-c and the third EH-capable device 210-d may not respond.

At 515-a, the wireless device 205-b may output, to the EH-capable devices 210-b, 210-c, 210-d, a first instance of a second query of a second round of signaling. The second round of signaling may include queries at (e.g., instances) 515-a and 515-b to 515-n. In the example of FIG. 5, the second EH-capable device 210-c may be within a second active period 535-c when the second query is communicated (e.g., transmitted or received).

At 520, the second EH-capable device 210-c may transmit second inventory data. For example, the second query may have an inventory type corresponding to the second EH-capable device 210-c and may be received within the second active period 535-c of the second EH-capable device 210-c. Accordingly, the second EH-capable device 210-c may respond by transmitting the second inventory data. In the example of FIG. 5, the first EH-capable device 210-b may be within a first active period 535-b when the second query at 515-a is communicated (e.g., transmitted or received). The second inventory type may not correspond to the first EH-capable device 210-b. Accordingly, the first EH-capable device 210-b may not respond to the first instance of the second query.

At 525-a, the wireless device 205-b may output, to the EH-capable devices 210-b, 210-c, 210-d, a first instance of a third query of a third round of signaling. The third round of signaling may include queries at (e.g., instances) 525-a and 525-b to 525-n. In the example of FIG. 5, the third EH-capable device 210-d may not be within a third active period 535-d when the third query is transmitted. In the example of FIG. 5, the first EH-capable device 210-b may be within the first active period 535-b and the second EH-capable device 210-c may be within the second active period 535-c when the first instance of the third query at 525-a is communicated (e.g., transmitted or received). The third inventory type may not correspond to the first EH-capable device 210-b or to the second EH-capable device. Accordingly, the first EH-capable device 210-b and the second EH-capable device may not respond to the first instance of the third query.

At 505-b, the wireless device 205-b may output, to the EH-capable devices 210-b, 210-c, 210-d, a second instance of the first query of the first round of signaling. The first EH-capable device 210-b has already responded to the first instance of the first query. Accordingly, the first EH-capable device 210-b does not respond to the second instance of the first query during the first active period 535-b. The second EH-capable device 210-c and the third EH-capable device 210-d may be inactive (e.g., within inactive periods) when the second instance of the first query is communicated (e.g., transmitted or received). Accordingly, the second EH-capable device 210-c and the third EH-capable device 210-d may not respond to the second instance of the first query.

At 515-b, the wireless device 205-b may output, to the EH-capable devices 210-b, 210-c, 210-d, a second instance of the second query of the second round of signaling. The first EH-capable device 210-b, the second EH-capable device 210-c, and the third EH-capable device 210-d may be inactive (e.g., within inactive periods) when the second instance of the second query is communicated (e.g., transmitted or received). Accordingly, the first EH-capable device 210-b, the second EH-capable device 210-c, and the third EH-capable device 210-d may not respond to the second instance of the second query.

At 525-b, the wireless device 205-b may output, to the EH-capable devices 210-b, 210-c, 210-d, a second instance of a third query of a third round of signaling. In the example of FIG. 5, the third EH-capable device 210-d is within a third active period 535-d when the second instance of the third query is transmitted.

At 530, the third EH-capable device 210-d may transmit third inventory data. For example, the second instance of the third query may have an inventory type corresponding to the third EH-capable device 210-d and may be received within the third active period 535-d of the third EH-capable device 210-d. Accordingly, the third EH-capable device 210-d may respond by transmitting the third inventory data. In the example of FIG. 5, the first EH-capable device 210-b and the second EH-capable device 210-c may be inactive when the second instance of the third query at 525-b is communicated (e.g., transmitted or received). Accordingly, the first EH-capable device 210-b and the second EH-capable device may not respond to the second instance of the third query.

At 505-n, the wireless device 205-b may output, to the EH-capable devices 210-b, 210-c, 210-d, a last (e.g., n-th) instance of the first query of the first round of signaling. At 515-n, the wireless device 205-b may output, to the EH-capable devices 210-b, 210-c, 210-d, a last (e.g., n-th) instance of the second query of the second round of signaling. At 525-n, the wireless device 205-b may output, to the EH-capable devices 210-b, 210-c, 210-d, a last instance (e.g., n-th) of a third query of a third round of signaling. In the example of FIG. 5, the first EH-capable device 210-b, the second EH-capable device 210-c, and the third EH-capable device 210-d are inactive when the last instances of the first query, the second query, and the third query are transmitted. Accordingly, the first EH-capable device 210-b, the second EH-capable device 210-c, and the third EH-capable device 210-d may not respond to the last instances of the first query, the second query, and the third query.

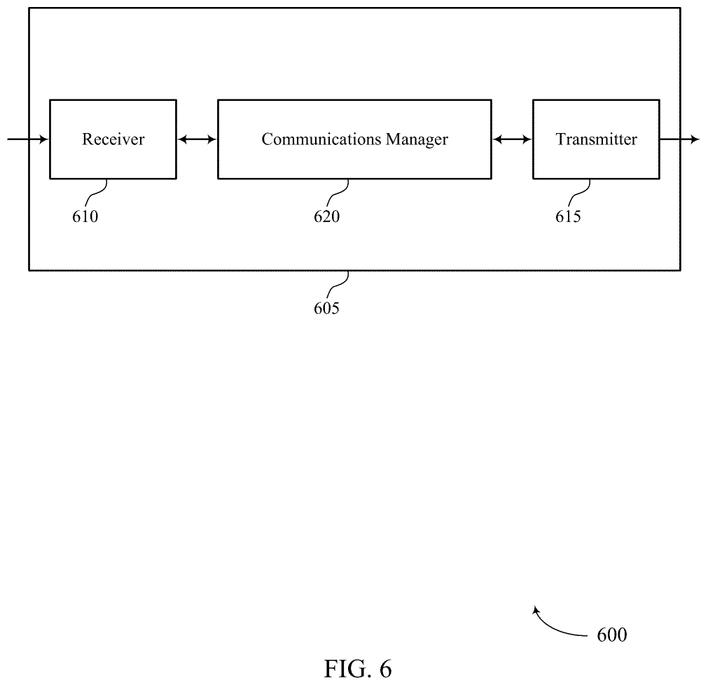

FIG. 6 shows a block diagram 600 of a device 605 that supports signal rounds for EH-capable devices in accordance with one or more aspects of the present disclosure. The device 605 may be an example of aspects of a wireless device (e.g., network entity 105 or UE 115) as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of signal rounds for EH-capable devices as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for outputting, within a first active period of an EH-capable device, first information associated with a first query for inventory data of the EH-capable device, the first information indicating a first inventory type and an instance of a first set of multiple instances associated with a first round of signaling from the wireless device. The communications manager 620 is capable of, configured to, or operable to support a means for outputting second information associated with a second query for inventory data of the EH-capable device, the second information indicating a second inventory type and an instance of a second set of multiple instances associated with a second round of signaling from the wireless device. The communications manager 620 is capable of, configured to, or operable to support a means for obtaining an indication of inventory data for the first inventory type or the second inventory type from the EH-capable device in response to the first information or the second information.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, or more efficient utilization of communication resources.

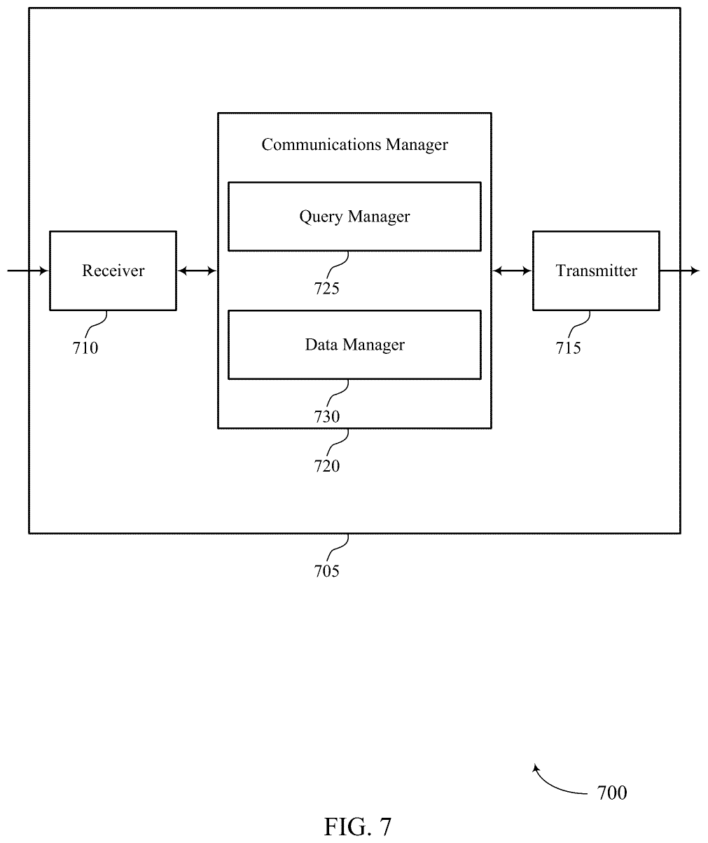

FIG. 7 shows a block diagram 700 of a device 705 that supports signal rounds for EH-capable devices in accordance with one or more aspects of the present disclosure. The device 705 may be an example of aspects of a device 605 or a wireless device 205 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of signal rounds for EH-capable devices as described herein. For example, the communications manager 720 may include a query manager 725 a data manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The query manager 725 is capable of, configured to, or operable to support a means for outputting, within a first active period of an EH-capable device, first information associated with a first query for inventory data of the EH-capable device, the first information indicating a first inventory type and an instance of a first set of multiple instances associated with a first round of signaling from the wireless device. The query manager 725 is capable of, configured to, or operable to support a means for outputting second information associated with a second query for inventory data of the EH-capable device, the second information indicating a second inventory type and an instance of a second set of multiple instances associated with a second round of signaling from the wireless device. The data manager 730 is capable of, configured to, or operable to support a means for obtaining an indication of inventory data for the first inventory type or the second inventory type from the EH-capable device in response to the first information or the second information.

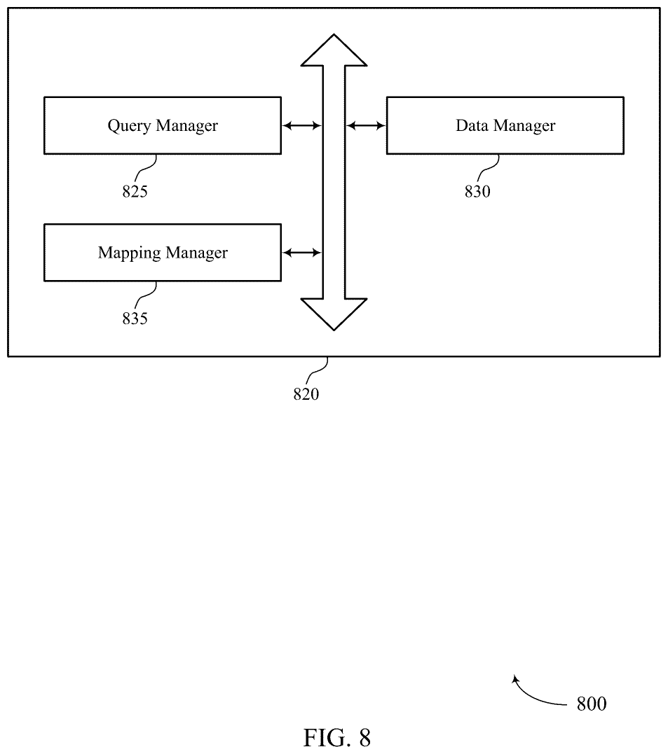

FIG. 8 shows a block diagram 800 of a communications manager 820 that supports signal rounds for EH-capable devices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of signal rounds for EH-capable devices as described herein. For example, the communications manager 820 may include a query manager 825, a data manager 830, a mapping manager 835, or any combination thereof. Each of these components, or components or subcomponents thereof (e.g., one or more processors, one or more memories), may communicate, directly or indirectly, with one another (e.g., via one or more buses).

The query manager 825 is capable of, configured to, or operable to support a means for outputting, within a first active period of an EH-capable device, first information associated with a first query for inventory data of the EH-capable device, the first information indicating a first inventory type and an instance of a first set of multiple instances associated with a first round of signaling from the wireless device. In some examples, the query manager 825 is capable of, configured to, or operable to support a means for outputting second information associated with a second query for inventory data of the EH-capable device, the second information indicating a second inventory type and an instance of a second set of multiple instances associated with a second round of signaling from the wireless device. The data manager 830 is capable of, configured to, or operable to support a means for obtaining an indication of inventory data for the first inventory type or the second inventory type from the EH-capable device in response to the first information or the second information.

In some examples, the query manager 825 is capable of, configured to, or operable to support a means for outputting the second set of multiple instances associated with the second round of signaling subsequent to the first set of multiple instances associated with the first round of signaling.

In some examples, to support outputting the second information, the query manager 825 is capable of, configured to, or operable to support a means for outputting the second information within a second active period subsequent to the first active period and a first inactive period of the EH-capable device.

In some examples, to support outputting the second information, the query manager 825 is capable of, configured to, or operable to support a means for outputting, between two instances of the first set of multiple instances, the second information for the instance of the second set of multiple instances.

In some examples, to support outputting the second information, the query manager 825 is capable of, configured to, or operable to support a means for outputting the second information within the first active period and prior to a first inactive period.

In some examples, to support outputting the second information, the query manager 825 is capable of, configured to, or operable to support a means for outputting the second information for the instance of the second set of multiple instances with the first information for the instance of the first set of multiple instances, where at least one of the second set of multiple instances is indicated with at least one of the first set of multiple instances.

In some examples, at least one of the second set of multiple instances is separate from at least one of the first set of multiple instances.

In some examples, the first information and the second information implicitly indicate a quantity of rounds of signaling for the first inventory type and the second inventory type.

In some examples, the instance of the first set of multiple instances is indicated as an offset relative to a previous instance of the first set of multiple instances or the instance of the second set of multiple instances is indicated as an offset relative to the first set of multiple instances.

In some examples, the mapping manager 835 is capable of, configured to, or operable to support a means for obtaining an indication of a mapping between the inventory data and the first round of signaling or the second round of signaling.

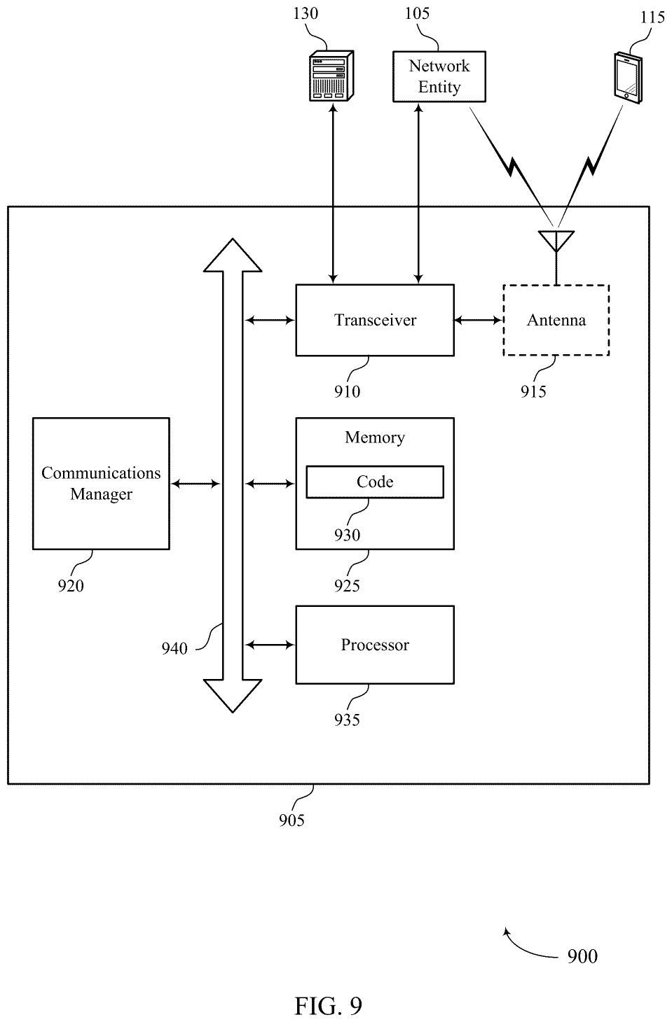

FIG. 9 shows a diagram of a system 900 including a device 905 that supports signal rounds for EH-capable devices in accordance with one or more aspects of the present disclosure. The device 905 may be an example of or include components of a device 605, a device 705, or a wireless device as described herein. The device 905 may include components for bi-directional voice and data communications including components for transmitting and receiving communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

In some examples, the device 905 may include an I/O controller. The I/O controller may manage input and output signals for the device 905. The I/O controller may also manage peripherals not integrated into the device 905. In some cases, the I/O controller may represent a physical connection or port to an external peripheral. In some cases, the I/O controller may utilize an operating system such as iOS®, ANDROID®, MS-DOS®, MS-WINDOWS®, OS/2®, UNIX®, LINUX®, or another known operating system. Additionally, or alternatively, the I/O controller may represent or interact with a modem, a keyboard, a mouse, a touchscreen, or a similar device. In some cases, the I/O controller may be implemented as part of one or more processors, such as the at least one processor 935. In some cases, a user may interact with the device 905 via the I/O controller or via hardware components controlled by the I/O controller.

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting signal rounds for EH-capable devices). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925). In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

In some examples, the communications manager 920 or I/O controller may manage aspects of communications with one or more devices (e.g., via one or more wired or wireless links). For example, the communications manager 920 or I/O controller may manage the transfer of data communications associated with one or more devices, such as one or more EH-capable devices, UEs 115, or network entities 105. In some examples, the communications manager 920 may include a controller or scheduler for controlling communications with one or more devices, such as EH-capable devices, UEs 115, or network entities 105 (e.g., in cooperation with one or more other EH-capable devices, UEs 115, or network entities 105). In some examples, the communications manager 920 or I/O controller may support backscattering based communication (e.g., one or more interrogating signals or responsive signals) for communication with an EH-capable device or other device.

For example, the communications manager 920 is capable of, configured to, or operable to support a means for outputting, within a first active period of an EH-capable device, first information associated with a first query for inventory data of the EH-capable device, the first information indicating a first inventory type and an instance of a first set of multiple instances associated with a first round of signaling from the wireless device. The communications manager 920 is capable of, configured to, or operable to support a means for outputting second information associated with a second query for inventory data of the EH-capable device, the second information indicating a second inventory type and an instance of a second set of multiple instances associated with a second round of signaling from the wireless device. The communications manager 920 is capable of, configured to, or operable to support a means for obtaining an indication of inventory data for the first inventory type or the second inventory type from the EH-capable device in response to the first information or the second information.

By including or configuring the communications manager 920 in accordance with examples as described herein, the device 905 may support techniques for improved communication reliability, reduced latency, reduced power consumption, more efficient utilization of communication resources, improved coordination between devices, longer battery life, or improved utilization of processing capability.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of signal rounds for EH-capable devices as described herein, or the at least one processor 935 and the at least one memory 925 may be otherwise configured to, individually or collectively, perform or support such operations.

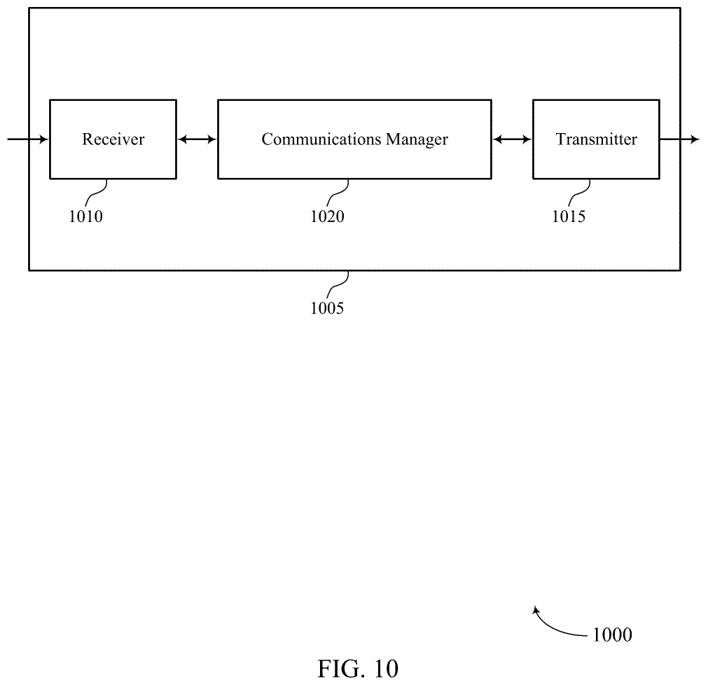

FIG. 10 shows a block diagram 1000 of a device 1005 that supports signal rounds for EH-capable devices in accordance with one or more aspects of the present disclosure. The device 1005 may be an example of aspects of an EH-capable device (e.g., EH-capable device 210, EH-capable device 210-a, EH-capable device 210-b, EH-capable device 210-c, or EH-capable device 210-d) as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to signal rounds for EH-capable devices). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to signal rounds for EH-capable devices). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of signal rounds for EH-capable devices as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for receiving, within a first active period, first information associated with a first query for inventory data of the EH-capable device from a wireless device, the first information indicating a first inventory type and an instance of a first set of multiple instances associated with a first round of signaling from the wireless device. The communications manager 1020 is capable of, configured to, or operable to support a means for receiving second information associated with a second query for inventory data of the EH-capable device from the wireless device, the second information indicating a second inventory type and an instance of a second set of multiple instances associated with a second round of signaling from the wireless device. The communications manager 1020 is capable of, configured to, or operable to support a means for transmitting an indication of inventory data for the first inventory type or the second inventory type to the wireless device in response to the first information or the second information.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, or more efficient utilization of communication resources.

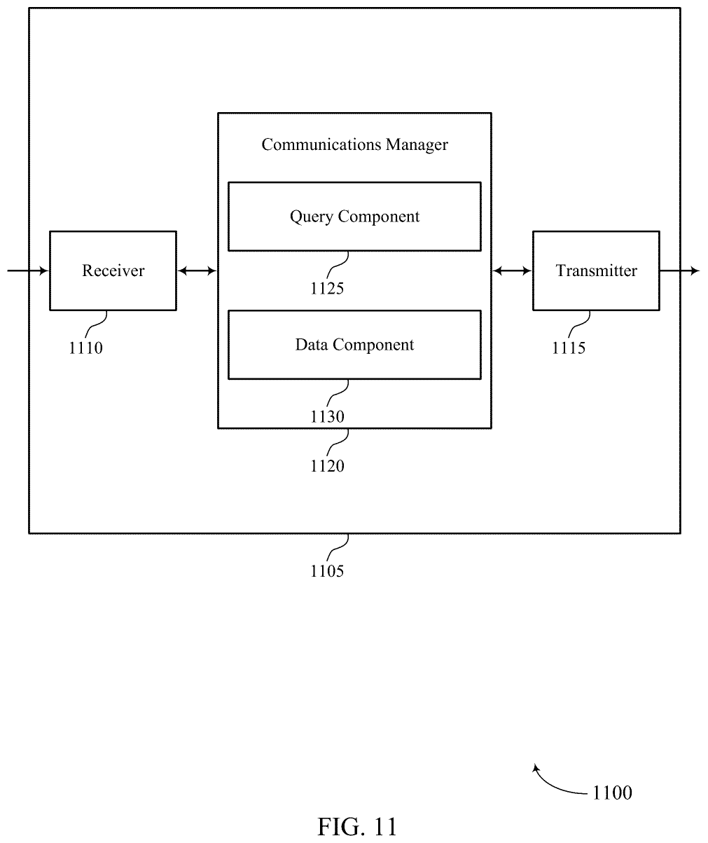

FIG. 11 shows a block diagram 1100 of a device 1105 that supports signal rounds for EH-capable devices in accordance with one or more aspects of the present disclosure. The device 1105 may be an example of aspects of a device 1005 or an EH-capable device 210 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to signal rounds for EH-capable devices). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to signal rounds for EH-capable devices). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of signal rounds for EH-capable devices as described herein. For example, the communications manager 1120 may include a query component 1125 a data component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The query component 1125 is capable of, configured to, or operable to support a means for receiving, within a first active period, first information associated with a first query for inventory data of the EH-capable device from a wireless device, the first information indicating a first inventory type and an instance of a first set of multiple instances associated with a first round of signaling from the wireless device. The query component 1125 is capable of, configured to, or operable to support a means for receiving second information associated with a second query for inventory data of the EH-capable device from the wireless device, the second information indicating a second inventory type and an instance of a second set of multiple instances associated with a second round of signaling from the wireless device. The data component 1130 is capable of, configured to, or operable to support a means for transmitting an indication of inventory data for the first inventory type or the second inventory type to the wireless device in response to the first information or the second information.

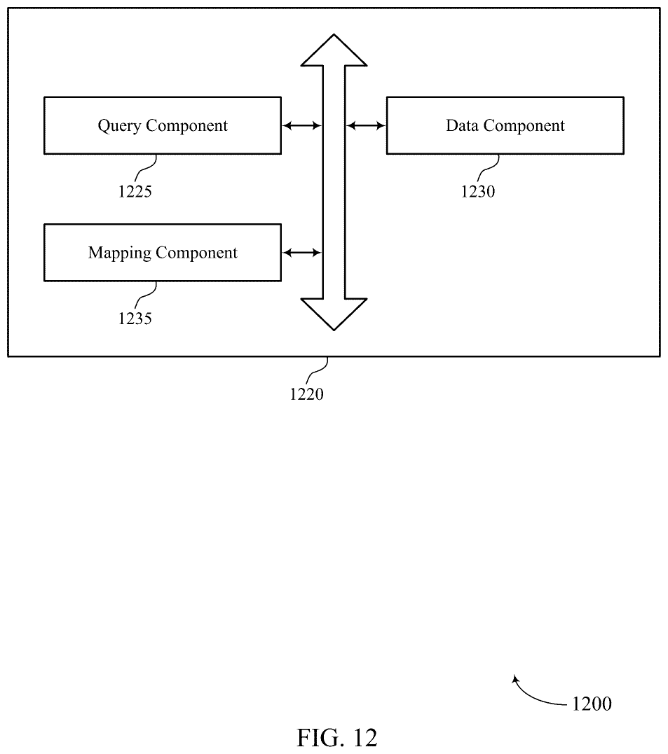

FIG. 12 shows a block diagram 1200 of a communications manager 1220 that supports signal rounds for EH-capable devices in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of signal rounds for EH-capable devices as described herein. For example, the communications manager 1220 may include a query component 1225, a data component 1230, a mapping component 1235, or any combination thereof. Each of these components, or components or subcomponents thereof (e.g., one or more processors, one or more memories), may communicate, directly or indirectly, with one another (e.g., via one or more buses).

The query component 1225 is capable of, configured to, or operable to support a means for receiving, within a first active period, first information associated with a first query for inventory data of the EH-capable device from a wireless device, the first information indicating a first inventory type and an instance of a first set of multiple instances associated with a first round of signaling from the wireless device. In some examples, the query component 1225 is capable of, configured to, or operable to support a means for receiving second information associated with a second query for inventory data of the EH-capable device from the wireless device, the second information indicating a second inventory type and an instance of a second set of multiple instances associated with a second round of signaling from the wireless device. The data component 1230 is capable of, configured to, or operable to support a means for transmitting an indication of inventory data for the first inventory type or the second inventory type to the wireless device in response to the first information or the second information.

In some examples, to support receiving the second information, the query component 1225 is capable of, configured to, or operable to support a means for receiving the second information for the instance of the second set of multiple instances, where the second set of multiple instances associated with the second round of signaling occurs subsequent to the first set of multiple instances associated with the first round of signaling.

In some examples, to support receiving the second information, the query component 1225 is capable of, configured to, or operable to support a means for receiving the second information within a second active period subsequent to the first active period and a first inactive period of the EH-capable device.

In some examples, to support receiving the second information, the query component 1225 is capable of, configured to, or operable to support a means for receiving, between two instances of the first set of multiple instances, the second information for the instance of the second set of multiple instances.

In some examples, to support receiving the second information, the query component 1225 is capable of, configured to, or operable to support a means for receiving the second information for the instance of the second set of multiple instances with the first information for the instance of the first set of multiple instances, where at least one of the second set of multiple instances is indicated with at least one of the first set of multiple instances.

In some examples, at least one of the second set of multiple instances is separate from at least one of the first set of multiple instances.

In some examples, the first information and the second information implicitly indicate a quantity of rounds of signaling for the first inventory type and the second inventory type.

In some examples, the instance of the first set of multiple instances is indicated as an offset relative to a previous instance of the first set of multiple instances or the instance of the second set of multiple instances is indicated as an offset relative to the first set of multiple instances.

In some examples, the mapping component 1235 is capable of, configured to, or operable to support a means for transmitting an indication of a mapping between the inventory data and the first round of signaling or the second round of signaling.

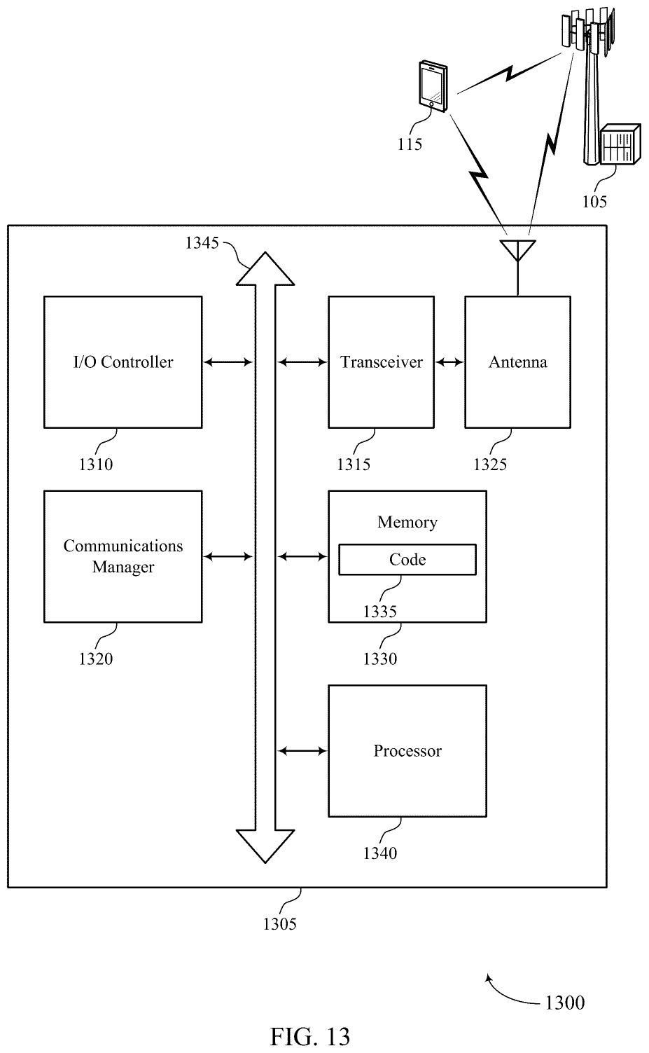

FIG. 13 shows a diagram of a system 1300 including a device 1305 that supports signal rounds for EH-capable devices in accordance with one or more aspects of the present disclosure. The device 1305 may be an example of or include components of a device 1005, a device 1105, or an EH-capable device as described herein. The device 1305 may include components for bi-directional voice and data communications including components for transmitting and receiving communications, such as a communications manager 1320, an I/O controller, such as an I/O controller 1310, a transceiver 1315, one or more antennas 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include RAM and ROM. The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may include, among other things, a BIOS which may control basic hardware or software operation such as the interaction with peripheral components or devices.

The at least one processor 1340 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting signal rounds for EH-capable devices). For example, the device 1305 or a component of the device 1305 may include at least one processor 1340 and at least one memory 1330 coupled with or to the at least one processor 1340, the at least one processor 1340 and the at least one memory 1330 configured to perform various functions described herein. In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (e.g., processor-executable code) stored in the at least one memory 1330 or otherwise, to perform one or more of the functions described herein.

In some examples, the communications manager 1320 or I/O controller 1310 may manage aspects of communications with one or more devices (e.g., via one or more wired or wireless links). For example, the communications manager 1320 or I/O controller 1310 may manage the transfer of data communications associated with one or more devices, such as one or more wireless devices (e.g., one or more UEs 115 or network entities 105). In some examples, the communications manager 1320 may include a controller or scheduler for controlling communications with one or more wireless devices, such as UEs 115 or network entities 105 (e.g., in cooperation with one or more other EH-capable devices, UEs 115, or network entities 105). In some examples, the communications manager 1320 or I/O controller 1310 may support backscattering based communication (e.g., one or more interrogating signals or responsive signals) for communication with a wireless device or other device.

For example, the communications manager 1320 is capable of, configured to, or operable to support a means for receiving, within a first active period, first information associated with a first query for inventory data of the EH-capable device from a wireless device, the first information indicating a first inventory type and an instance of a first set of multiple instances associated with a first round of signaling from the wireless device. The communications manager 1320 is capable of, configured to, or operable to support a means for receiving second information associated with a second query for inventory data of the EH-capable device from the wireless device, the second information indicating a second inventory type and an instance of a second set of multiple instances associated with a second round of signaling from the wireless device. The communications manager 1320 is capable of, configured to, or operable to support a means for transmitting an indication of inventory data for the first inventory type or the second inventory type to the wireless device in response to the first information or the second information.

By including or configuring the communications manager 1320 in accordance with examples as described herein, the device 1305 may support techniques for improved communication reliability, reduced latency, reduced power consumption, more efficient utilization of communication resources, improved coordination between devices, longer battery life, or improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of signal rounds for EH-capable devices as described herein, or the at least one processor 1340 and the at least one memory 1330 may be otherwise configured to, individually or collectively, perform or support such operations.

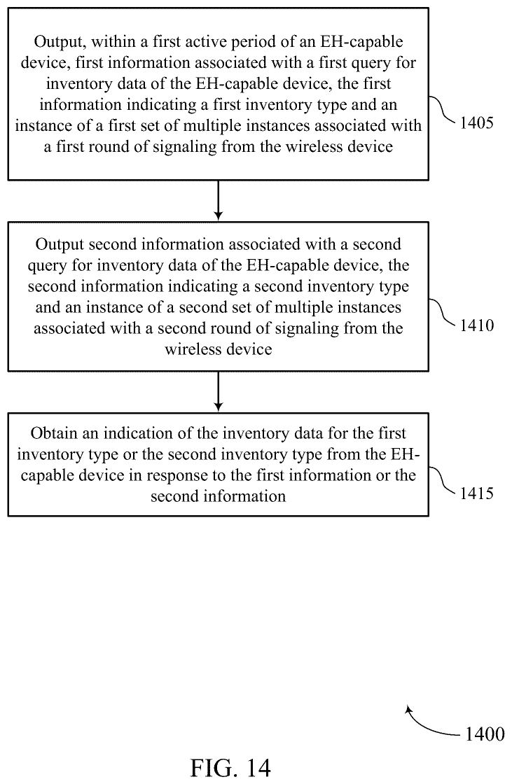

FIG. 14 shows a flowchart illustrating a method 1400 that supports signal rounds for EH-capable devices in accordance with one or more aspects of the present disclosure. The operations of the method 1400 may be implemented by a wireless device or its components as described herein. For example, the operations of the method 1400 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1405, the method may include outputting, within a first active period of an EH-capable device, first information associated with a first query for inventory data of the EH-capable device, the first information indicating a first inventory type and an instance of a first set of multiple instances associated with a first round of signaling from the wireless device. The operations of 1405 may be performed in accordance with examples as disclosed herein. In some examples, aspects of the operations of 1405 may be performed by a query manager 825 as described with reference to FIG. 8.

At 1410, the method may include outputting second information associated with a second query for inventory data of the EH-capable device, the second information indicating a second inventory type and an instance of a second set of multiple instances associated with a second round of signaling from the wireless device. The operations of 1410 may be performed in accordance with examples as disclosed herein. In some examples, aspects of the operations of 1410 may be performed by a query manager 825 as described with reference to FIG. 8.

At 1415, the method may include obtaining an indication of inventory data for the first inventory type or the second inventory type from the EH-capable device in response to the first information or the second information. The operations of 1415 may be performed in accordance with examples as disclosed herein. In some examples, aspects of the operations of 1415 may be performed by a data manager 830 as described with reference to FIG. 8.

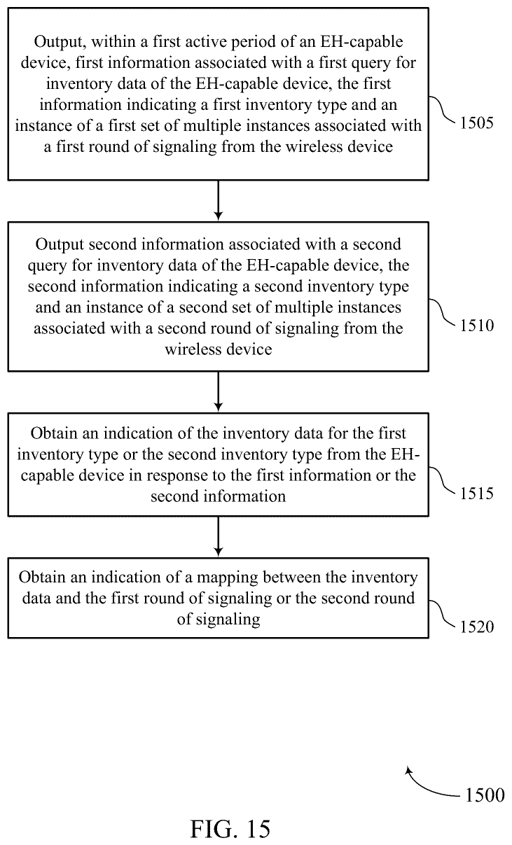

FIG. 15 shows a flowchart illustrating a method 1500 that supports signal rounds for EH-capable devices in accordance with one or more aspects of the present disclosure. The operations of the method 1500 may be implemented by a wireless device or its components as described herein. For example, the operations of the method 1500 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1505, the method may include outputting, within a first active period of an EH-capable device, first information associated with a first query for inventory data of the EH-capable device, the first information indicating a first inventory type and an instance of a first set of multiple instances associated with a first round of signaling from the wireless device. The operations of 1505 may be performed in accordance with examples as disclosed herein. In some examples, aspects of the operations of 1505 may be performed by a query manager 825 as described with reference to FIG. 8.

At 1510, the method may include outputting second information associated with a second query for inventory data of the EH-capable device, the second information indicating a second inventory type and an instance of a second set of multiple instances associated with a second round of signaling from the wireless device. The operations of 1510 may be performed in accordance with examples as disclosed herein. In some examples, aspects of the operations of 1510 may be performed by a query manager 825 as described with reference to FIG. 8.

At 1515, the method may include obtaining an indication of inventory data for the first inventory type or the second inventory type from the EH-capable device in response to the first information or the second information. The operations of 1515 may be performed in accordance with examples as disclosed herein. In some examples, aspects of the operations of 1515 may be performed by a data manager 830 as described with reference to FIG. 8.

At 1520, the method may include obtaining an indication of a mapping between the inventory data and the first round of signaling or the second round of signaling. The operations of 1520 may be performed in accordance with examples as disclosed herein. In some examples, aspects of the operations of 1520 may be performed by a mapping manager 835 as described with reference to FIG. 8.

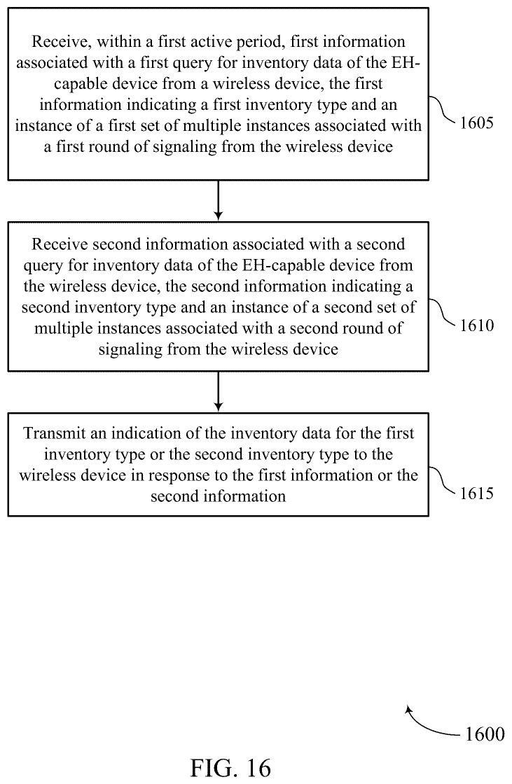

FIG. 16 shows a flowchart illustrating a method 1600 that supports signal rounds for EH-capable devices in accordance with one or more aspects of the present disclosure. The operations of the method 1600 may be implemented by an EH-capable device or its components as described herein. For example, the operations of the method 1600 may be performed by an EH-capable device as described with reference to FIGS. 1 through 5 and 10 through 13. In some examples, an EH-capable device may execute a set of instructions to control the functional elements of the EH-capable device to perform the described functions. Additionally, or alternatively, the EH-capable device may perform aspects of the described functions using special-purpose hardware.

At 1605, the method may include receiving, within a first active period, first information associated with a first query for inventory data of the EH-capable device from a wireless device, the first information indicating a first inventory type and an instance of a first set of multiple instances associated with a first round of signaling from the wireless device. The operations of 1605 may be performed in accordance with examples as disclosed herein. In some examples, aspects of the operations of 1605 may be performed by a query component 1225 as described with reference to FIG. 12.

At 1610, the method may include receiving second information associated with a second query for inventory data of the EH-capable device from the wireless device, the second information indicating a second inventory type and an instance of a second set of multiple instances associated with a second round of signaling from the wireless device. The operations of 1610 may be performed in accordance with examples as disclosed herein. In some examples, aspects of the operations of 1610 may be performed by a query component 1225 as described with reference to FIG. 12.

At 1615, the method may include transmitting an indication of inventory data for the first inventory type or the second inventory type to the wireless device in response to the first information or the second information. The operations of 1615 may be performed in accordance with examples as disclosed herein. In some examples, aspects of the operations of 1615 may be performed by a data component 1230 as described with reference to FIG. 12.

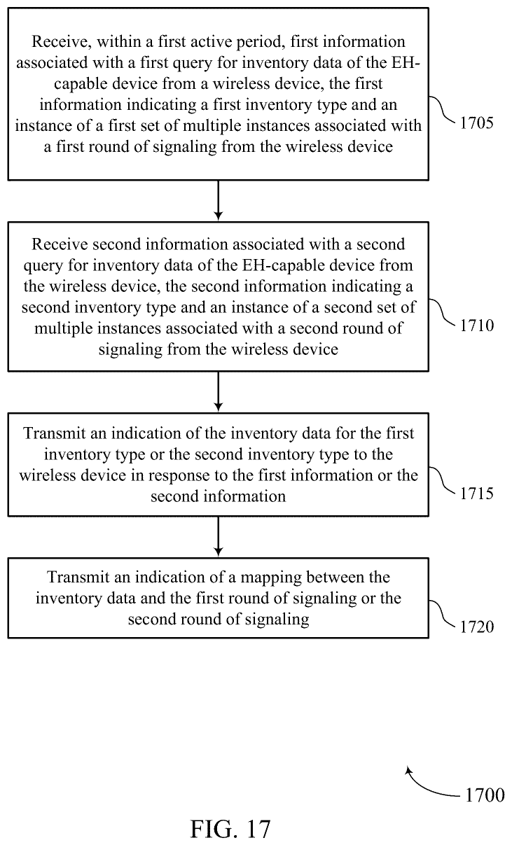

FIG. 17 shows a flowchart illustrating a method 1700 that supports signal rounds for EH-capable devices in accordance with one or more aspects of the present disclosure. The operations of the method 1700 may be implemented by an EH-capable device or its components as described herein. For example, the operations of the method 1700 may be performed by an EH-capable device as described with reference to FIGS. 1 through 5 and 10 through 13. In some examples, an EH-capable device may execute a set of instructions to control the functional elements of the EH-capable device to perform the described functions. Additionally, or alternatively, the EH-capable device may perform aspects of the described functions using special-purpose hardware.

At 1705, the method may include receiving, within a first active period, first information associated with a first query for inventory data of the EH-capable device from a wireless device, the first information indicating a first inventory type and an instance of a first set of multiple instances associated with a first round of signaling from the wireless device. The operations of 1705 may be performed in accordance with examples as disclosed herein. In some examples, aspects of the operations of 1705 may be performed by a query component 1225 as described with reference to FIG. 12.

At 1710, the method may include receiving second information associated with a second query for inventory data of the EH-capable device from the wireless device, the second information indicating a second inventory type and an instance of a second set of multiple instances associated with a second round of signaling from the wireless device. The operations of 1710 may be performed in accordance with examples as disclosed herein. In some examples, aspects of the operations of 1710 may be performed by a query component 1225 as described with reference to FIG. 12.

At 1715, the method may include transmitting an indication of inventory data for the first inventory type or the second inventory type to the wireless device in response to the first information or the second information. The operations of 1715 may be performed in accordance with examples as disclosed herein. In some examples, aspects of the operations of 1715 may be performed by a data component 1230 as described with reference to FIG. 12.

At 1720, the method may include transmitting an indication of a mapping between the inventory data and the first round of signaling or the second round of signaling. The operations of 1720 may be performed in accordance with examples as disclosed herein. In some examples, aspects of the operations of 1720 may be performed by a mapping component 1235 as described with reference to FIG. 12.

The following provides an overview of aspects of the present disclosure:

Aspect 1: A method for wireless communications at a wireless device, comprising: outputting, within a first active period of an EH-capable device, first information associated with a first query for inventory data of the EH-capable device, the first information indicating a first inventory type and an instance of a first plurality of instances associated with a first round of signaling from the wireless device; outputting second information associated with a second query for inventory data of the EH-capable device, the second information indicating a second inventory type and an instance of a second plurality of instances associated with a second round of signaling from the wireless device; and obtaining an indication of inventory data for the first inventory type or the second inventory type from the EH-capable device in response to the first information or the second information.

Aspect 2: The method of aspect 1, further comprising: outputting the second plurality of instances associated with the second round of signaling subsequent to the first plurality of instances associated with the first round of signaling.

Aspect 3: The method of aspect 2, wherein outputting the second information comprises: outputting the second information within a second active period subsequent to the first active period and a first inactive period of the EH-capable device.

Aspect 4: The method of aspect 1, wherein outputting the second information comprises: outputting, between two instances of the first plurality of instances, the second information for the instance of the second plurality of instances.

Aspect 5: The method of aspect 4, wherein outputting the second information comprises: outputting the second information within the first active period and prior to a first inactive period.

Aspect 6: The method of aspect 1, wherein outputting the second information comprises: outputting the second information for the instance of the second plurality of instances with the first information for the instance of the first plurality of instances, wherein at least one of the second plurality of instances is indicated with at least one of the first plurality of instances.

Aspect 7: The method of aspect 6, wherein at least one of the second plurality of instances is separate from at least one of the first plurality of instances.

Aspect 8: The method of any of aspects 6 through 7, wherein the first information and the second information implicitly indicate a quantity of rounds of signaling for the first inventory type and the second inventory type.

Aspect 9: The method of any of aspects 6 through 8, wherein the instance of the first plurality of instances is indicated as an offset relative to a previous instance of the first plurality of instances or the instance of the second plurality of instances is indicated as an offset relative to the first plurality of instances.

Aspect 10: The method of any of aspects 1 through 9, further comprising: obtaining an indication of a mapping between the inventory data and the first round of signaling or the second round of signaling.

Aspect 11: A method for wireless communications at an EH-capable device, comprising: receiving, within a first active period, first information associated with a first query for inventory data of the EH-capable device from a wireless device, the first information indicating a first inventory type and an instance of a first plurality of instances associated with a first round of signaling from the wireless device; receiving second information associated with a second query for inventory data of the EH-capable device from the wireless device, the second information indicating a second inventory type and an instance of a second plurality of instances associated with a second round of signaling from the wireless device; and transmitting an indication of inventory data for the first inventory type or the second inventory type to the wireless device in response to the first information or the second information.

Aspect 12: The method of aspect 11, wherein receiving the second information comprises: receiving the second information for the instance of the second plurality of instances, wherein the second plurality of instances associated with the second round of signaling occurs subsequent to the first plurality of instances associated with the first round of signaling.

Aspect 13: The method of aspect 12, wherein receiving the second information comprises: receiving the second information within a second active period subsequent to the first active period and a first inactive period of the EH-capable device.

Aspect 14: The method of aspect 11, wherein receiving the second information comprises: receiving, between two instances of the first plurality of instances, the second information for the instance of the second plurality of instances.

Aspect 15: The method of aspect 11, wherein receiving the second information comprises: receiving the second information for the instance of the second plurality of instances with the first information for the instance of the first plurality of instances, wherein at least one of the second plurality of instances is indicated with at least one of the first plurality of instances.

Aspect 16: The method of aspect 15, wherein at least one of the second plurality of instances is separate from at least one of the first plurality of instances.

Aspect 17: The method of any of aspects 15 through 16, wherein the first information and the second information implicitly indicate a quantity of rounds of signaling for the first inventory type and the second inventory type.

Aspect 18: The method of any of aspects 15 through 17, wherein the instance of the first plurality of instances is indicated as an offset relative to a previous instance of the first plurality of instances or the instance of the second plurality of instances is indicated as an offset relative to the first plurality of instances.

Aspect 19: The method of any of aspects 11 through 18, further comprising: transmitting an indication of a mapping between the inventory data and the first round of signaling or the second round of signaling.

Aspect 20: A wireless device comprising one or more memories storing processor-executable code, and one or more processors coupled (e.g., operatively, communicatively, functionally, electronically, or electrically) with the one or more memories and individually or collectively operable (e.g., directly, indirectly, after pre-processing, without pre-processing) to execute the code to cause the wireless device to perform a method of any of aspects 1 through 10.

Aspect 21: A wireless device comprising at least one means for performing a method of any of aspects 1 through 10.

Aspect 22: A non-transitory computer-readable medium storing code for wireless communications at a wireless device, the code comprising instructions executable by at least one processor (e.g., directly, indirectly, after pre-processing, without pre-processing) to perform a method of any of aspects 1 through 10.

Aspect 23: An EH-capable device comprising one or more memories storing processor-executable code, and one or more processors coupled (e.g., operatively, communicatively, functionally, electronically, or electrically) with the one or more memories and individually or collectively operable (e.g., directly, indirectly, after pre-processing, without pre-processing) to execute the code to cause the EH-capable device to perform a method of any of aspects 11 through 19.

Aspect 24: An EH-capable device comprising at least one means for performing a method of any of aspects 11 through 19.

Aspect 25: A non-transitory computer-readable medium storing code for wireless communications at an EH-capable device, the code comprising instructions executable by at least one processor (e.g., directly, indirectly, after pre-processing, without pre-processing) to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
output, within a first active period of an energy harvesting (EH)-capable device, first information associated with a first query for inventory data of the EH-capable device, the first information indicating a first inventory type and an instance of a first plurality of instances associated with a first round of signaling from the wireless device;
output second information associated with a second query for inventory data of the EH-capable device, the second information indicating a second inventory type and an instance of a second plurality of instances associated with a second round of signaling from the wireless device; and
obtain an indication of inventory data for the first inventory type or the second inventory type from the EH-capable device in response to the first information or the second information.

2. The wireless device of claim 1, wherein the one or more processors are individually or collectively further operable to execute the code to cause the wireless device to:
output the second plurality of instances associated with the second round of signaling subsequent to the first plurality of instances associated with the first round of signaling.

3. The wireless device of claim 2, wherein, to output the second information, the one or more processors are individually or collectively operable to execute the code to cause the wireless device to:
output the second information within a second active period subsequent to the first active period and a first inactive period of the EH-capable device.

4. The wireless device of claim 1, wherein, to output the second information, the one or more processors are individually or collectively operable to execute the code to cause the wireless device to:
output, between two instances of the first plurality of instances, the second information for the instance of the second plurality of instances.

5. The wireless device of claim 4, wherein, to output the second information, the one or more processors are individually or collectively operable to execute the code to cause the wireless device to:
output the second information within the first active period and prior to a first inactive period.

6. The wireless device of claim 1, wherein, to output the second information, the one or more processors are individually or collectively operable to execute the code to cause the wireless device to:
output the second information for the instance of the second plurality of instances with the first information for the instance of the first plurality of instances, wherein at least one of the second plurality of instances is indicated with at least one of the first plurality of instances.

7. The wireless device of claim 6, wherein at least one of the second plurality of instances is separate from at least one of the first plurality of instances.

8. The wireless device of claim 6, wherein the first information and the second information implicitly indicate a quantity of rounds of signaling for the first inventory type and the second inventory type.

9. The wireless device of claim 6, wherein the instance of the first plurality of instances is indicated as an offset relative to a previous instance of the first plurality of instances or the instance of the second plurality of instances is indicated as an offset relative to the first plurality of instances.

10. The wireless device of claim 1, wherein the one or more processors are individually or collectively further operable to execute the code to cause the wireless device to:
obtain an indication of a mapping between the inventory data and the first round of signaling or the second round of signaling.

11. An energy harvesting (EH)-capable device, comprising:
one or more memories storing processor-executable code; and
one or more processors coupled with the one or more memories and individually or collectively operable to execute the code to cause the EH-capable device to:
receive, within a first active period, first information associated with a first query for inventory data of the EH-capable device from a wireless device, the first information indicating a first inventory type and an instance of a first plurality of instances associated with a first round of signaling from the wireless device;
receive second information associated with a second query for inventory data of the EH-capable device from the wireless device, the second information indicating a second inventory type and an instance of a second plurality of instances associated with a second round of signaling from the wireless device; and
transmit an indication of inventory data for the first inventory type or the second inventory type to the wireless device in response to the first information or the second information.

12. The EH-capable device of claim 11, wherein, to receive the second information, the one or more processors are individually or collectively operable to execute the code to cause the EH-capable device to:
receive the second information for the instance of the second plurality of instances, wherein the second plurality of instances associated with the second round of signaling occurs subsequent to the first plurality of instances associated with the first round of signaling.

13. The EH-capable device of claim 12, wherein, to receive the second information, the one or more processors are individually or collectively operable to execute the code to cause the EH-capable device to:
receive the second information within a second active period subsequent to the first active period and a first inactive period of the EH-capable device.

14. The EH-capable device of claim 11, wherein, to receive the second information, the one or more processors are individually or collectively operable to execute the code to cause the EH-capable device to:
receive, between two instances of the first plurality of instances, the second information for the instance of the second plurality of instances.

15. The EH-capable device of claim 11, wherein, to receive the second information, the one or more processors are individually or collectively operable to execute the code to cause the EH-capable device to:
receive the second information for the instance of the second plurality of instances with the first information for the instance of the first plurality of instances, wherein at least one of the second plurality of instances is indicated with at least one of the first plurality of instances.

16. The EH-capable device of claim 15, wherein at least one of the second plurality of instances is separate from at least one of the first plurality of instances.

17. The EH-capable device of claim 15, wherein the first information and the second information implicitly indicate a quantity of rounds of signaling for the first inventory type and the second inventory type.

18. The EH-capable device of claim 15, wherein the instance of the first plurality of instances is indicated as an offset relative to a previous instance of the first plurality of instances or the instance of the second plurality of instances is indicated as an offset relative to the first plurality of instances.

19. The EH-capable device of claim 11, wherein the one or more processors are individually or collectively further operable to execute the code to cause the EH-capable device to:
transmit an indication of a mapping between the inventory data and the first round of signaling or the second round of signaling.

20. A method for wireless communications at a wireless device, comprising:
outputting, within a first active period of an energy harvesting (EH)-capable device, first information associated with a first query for inventory data of the EH-capable device, the first information indicating a first inventory type and an instance of a first plurality of instances associated with a first round of signaling from the wireless device;
outputting second information associated with a second query for inventory data of the EH-capable device, the second information indicating a second inventory type and an instance of a second plurality of instances associated with a second round of signaling from the wireless device; and
obtaining an indication of inventory data for the first inventory type or the second inventory type from the EH-capable device in response to the first information or the second information.
